(19) United States
(12) Patent Application Publication
(10) Pub. No.: US 2026/0067914 A1
(43) Pub. Date: Mar. 5, 2026

(54) RESOURCE CONFIGURATION METHOD AND COMMUNICATION DEVICE

(71) Applicant: GUANGDONG OPPO MOBILE TELECOMMUNICATIONS CORP., LTD., Dongguan (CN)

(72) Inventors: Teng MA, Dongguan (CN); Zhenshan ZHAO, Dongguan (CN); Shichang ZHANG, Dongguan (CN)

(21) Appl. No.: 19/384,095

(22) Filed: Nov. 10, 2025

Related U.S. Application Data
(63) Continuation of application No. PCT/CN2023/107525, filed on Jul. 14, 2023.

(51) Int. Cl. H04W 72/51; H04W 72/0446; H04W 72/25

(52) U.S. Cl. CPC H04W 72/51; H04W 72/0446; H04W 72/25

(57) ABSTRACT

A method for resource configuration and a communication device are provided. The method includes an operation that a terminal acquires first configuration information. The first configuration information is used for determining a first-type sidelink synchronization signal block (S-SSB) synchronization resource and a second-type S-SSB synchronization resource, the first-type S-SSB synchronization resource corresponds to a first-type terminal, and the second-type S-SSB synchronization resource corresponds to a second-type terminal, and the first-type terminal has a higher capability than the second-type terminal.

### CROSS-REFERENCE TO RELATED APPLICATION

This is a continuation application of International Patent Application No. PCT/CN2023/107525, filed on Jul. 14, 2023, the disclosure of which is hereby incorporated by reference in its entirety.

### BACKGROUND

Reduced Capability (RedCap) is a new technology defined in the 3rd Generation Partnership Project (3GPP). In discussion of the Sidelink in Unlicensed Spectrum (SL-U) technology topic, all terminals have the same capability, but the reduced-capability terminals are not taken into account. The costs and power consumption of the terminals are very important indexes during commercial deployment. The low costs and low power consumption brought by the reduced-capability terminals can provide a convenient passage for commercialization of the SL-U technology. Therefore, it may be considered to introduce the reduced-capability terminals into the sidelink (SL) systems.

Relative to the traditional terminals (which may also be referred to as a full-capability terminal or a strong-capability terminal), the reduced-capability terminals have different capabilities. Therefore, the current sidelink synchronization schemes (that is, the sidelink synchronization schemes applicable to the traditional terminals) are not applicable to the reduced-capability terminals.

### SUMMARY

The embodiments of the disclosure relate to the technical field of mobile communications, and in particular to a method for resource configuration and a communication device.

A first aspect of the embodiments of the disclosure provides a method for resource configuration, which including an operation as follows. First configuration information is acquired by a terminal. The first configuration information is used for determining a first-type sidelink synchronization signal block (S-SSB) synchronization resource and a second-type S-SSB synchronization resource, the first-type S-SSB synchronization resource corresponds to a first-type terminal, and the second-type S-SSB synchronization resource corresponds to a second-type terminal, and the first-type terminal has a higher capability than the second-type terminal.

A second aspect of the embodiments of the disclosure provides a method for resource configuration, which includes an operation as follows. A network device transmits first configuration information. The first configuration information is used for determining a first-type sidelink synchronization signal block (S-SSB) synchronization resource and a second-type S-SSB synchronization resource, the first-type S-SSB synchronization resource corresponds to a first-type terminal, and the second-type S-SSB synchronization resource corresponds to a second-type terminal, and the first-type terminal has a higher capability than the second-type terminal.

A third aspect of the embodiments of the disclosure provides a communication device including a memory and a processor. The memory is configured to store computer-executable instructions, and the processor is connected to the memory and is configured to execute the computer-executable instructions to implement the method of any above aspect.

### BRIEF DESCRIPTION OF THE DRAWINGS

The drawings described herein are used for further understanding of the disclosure, and constitute a part of the disclosure. Exemplary embodiments of the disclosure and description thereof are used to explain the disclosure and do not form inappropriate limitation for the disclosure. In the drawings:

FIG. 1A is a schematic diagram of sidelink communication within the network coverage according to the embodiments of the disclosure;

FIG. 1B is a schematic diagram of sidelink communication within a part of the network coverage according to the embodiments of the disclosure;

FIG. 1C is a schematic diagram of sidelink communication outside the network coverage according to the embodiments of the disclosure;

FIG. 1D is a schematic diagram of sidelink communication having a central control node according to the embodiments of the disclosure;

FIG. 2A is a schematic diagram of a unicast transmission mode according to the embodiments of the disclosure;

FIG. 2B is a schematic diagram of a multicast transmission mode according to the embodiments of the disclosure;

FIG. 2C is a schematic diagram of a broadcast transmission mode according to the embodiments of the disclosure;

FIG. 3A is a first schematic diagram of a new radio vehicle-to-everything (NR-V2X) frame structure according to the embodiments of the disclosure;

FIG. 3B is a second schematic diagram of an NR-V2X frame structure according to embodiments of the disclosure;

FIG. 4 is a structural diagram of a sidelink synchronization signal block (S-SSB) slot according to the embodiments of the disclosure;

FIG. 5 is a schematic diagram of NR-V2X synchronization resources according to the embodiments of the disclosure;

FIG. 6 is a schematic diagram of a set of synchronization resources in a synchronization period according to the embodiments of the disclosure;

FIG. 7 is a schematic flowchart of a method for resource configuration according to the embodiments of the disclosure;

FIG. 8 is a first schematic diagram of S-SSB slots configured in a synchronization period according to the embodiments of the disclosure;

FIG. 9 is a second schematic diagram of S-SSB slots configured in a synchronization period according to the embodiments of the disclosure;

FIG. 10 is a third schematic diagram of S-SSB slots configured in a synchronization period according to the embodiments of the disclosure;

FIG. 11 is a fourth schematic diagram of S-SSB slots configured in synchronization periods according to the embodiments of the disclosure;

FIG. 12 is a schematic diagram of time-frequency resources of S-SSB synchronization resources according to embodiments of the disclosure;

FIG. 13 is a first schematic structural diagram of a composition of a device for resource configuration according to the embodiments of the disclosure;

FIG. 14 is a second schematic structural diagram of a composition of a device for resource configuration according to embodiments of the disclosure;

FIG. 15 is a schematic structural diagram of a communication device according to the embodiments of the disclosure;

FIG. 16 is a schematic structural diagram of a chip according to the embodiments of the disclosure;

FIG. 17 is a schematic block diagram of a communication system according to the embodiments of the disclosure.

### DETAILED DESCRIPTION

Technical solutions of the embodiments of the disclosure will be described below in conjunction with the drawings of the embodiments of the disclosure. Apparently, the described embodiments are some rather than all embodiments of the disclosure. All other embodiments obtained by those skilled in the art based on the embodiments of the disclosure without paying any inventive effort shall fall within the scope of protection of the disclosure.

The technical solutions of the embodiments of the disclosure may be applied to various sidelink communication systems (which may also be referred to as sidelink systems). For convenience in understanding the technical solutions of the embodiments of the disclosure, the relevant technologies in a sidelink communication system are described hereinafter. The following relevant technologies may be as optional solutions combined with the technical solutions of the embodiments of the disclosure arbitrarily, and the combination shall fall within the scope of protection of the embodiments of the disclosure.

### Sidelink Communication Under Different Network Coverage Environments

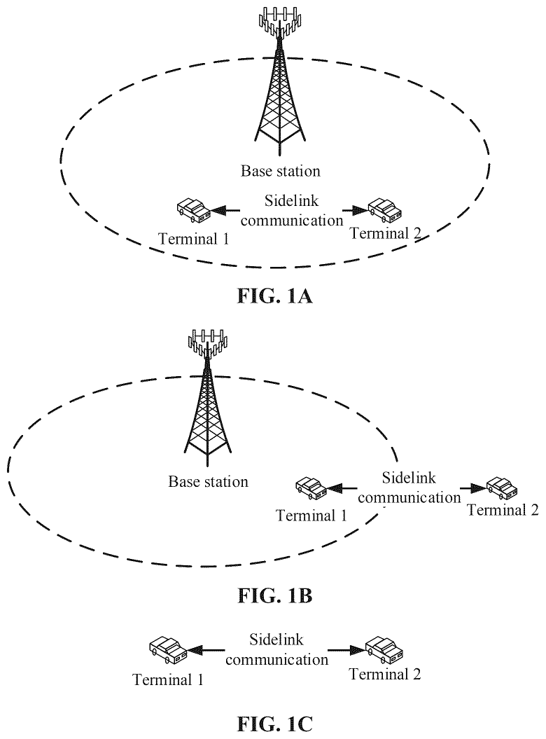

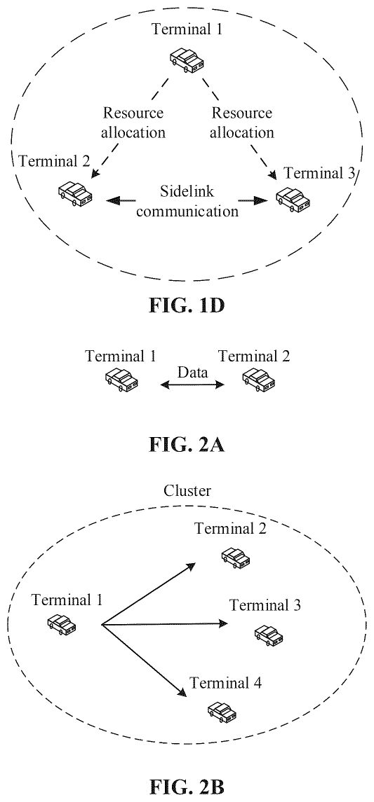

According to the network coverage where the terminal performing communication is located, sidelink communication may include sidelink communication within the network coverage, sidelink communication within the partial network coverage, sidelink communication outside the network coverage, and sidelink communication with a central control node, which are illustrated in FIGS. 1A, 1B, 1C, and 1D respectively.

In the sidelink communication within the network coverage as illustrated in FIG. 1A, the terminals (such as terminal 1 and terminal 2 in FIG. 1A) performing sidelink communication are all within the coverage of a same base station, and the terminals can perform sidelink communication based on the same sidelink configuration by receiving configuration signaling from the base station.

In the sidelink communication within the partial network coverage as illustrated in FIG. 1B, a part of terminals (such as terminal 1 in FIG. 1B) performing sidelink communication is/are located within the coverage of the base station, and the part of the terminals can receive configuration signaling from the base station and perform sidelink communication according to the configuration of the base station. However, a terminal (such as terminal 2 in FIG. 1B) outside the network coverage cannot receive configuration signaling from the base station. In this case, the terminal outside the network coverage will determine sidelink configuration for sidelink communication according to pre-configuration information and information carried in a Physical Sidelink Broadcast Channel (PSBCH) transmitted by the terminal within the network coverage.

In the sidelink communication outside the network coverage as illustrated in FIG. 1C, all terminals (such as terminal 1 and terminal 2 in FIG. 1C) performing sidelink communication are located outside the network coverage, and all the terminals determine sidelink configuration for sidelink communication according to pre-configuration information.

In the sidelink communication with a central control node as illustrated in FIG. 1D, multiple terminals form a communication cluster. The communication cluster includes a central control node (such as terminal 1 in FIG. 1D), which may also become a cluster header (CH). The central control node has one of following functions: establishing the communication cluster; enabling a cluster member(s) to join and depart; performing resource coordination, including allocating sidelink transmission resources for other terminals (such as terminal 2 and terminal 3 in FIGS. 1-4), and receiving sidelink feedback information from other terminals; performing resource coordination with other communication clusters and so on.

A terminal in the sidelink system may be any terminal, including but not limited to a terminal in wired or wireless connection with a network device and/or another terminal. For example, the terminal may refer to an access terminal, user equipment (UE), a subscriber unit, a subscriber station, a mobile station, a remote station, a remote terminal, a mobile device, a user terminal, a terminal, a wireless communication device, a subscriber agent or a user device. The access terminal may be a cellular phone, a cordless phone, a session initiation protocol (SIP) phone, an Internet of Things (IOT) device, a hand-held satellite terminal, a wireless local loop (WLL) station, a personal digital assistant (PDA), a hand-held device with a wireless communication function, a computing device or another processing device connected to a radio modem, a vehicle-mounted device, a wearable device, a terminal in the 5G network, a terminal in a future evolved network or the like.

### Resource Selection Mode in Sidelink Communication

Device-to-device (D2D) communication is a D2D sidelink transmission technology, which is different from a traditional cellular system in which communication data is received or transmitted through a base station, and thus has a higher spectral efficiency and a lower transmission delay. Terminal-to-terminal direct communication is adopted in sidelink communication. The 3rd Generation Partnership Project (3GPP) defines two transmission modes: a first mode and a second mode.

In the first mode, transmission resources of a terminal are allocated by a base station, and the terminal transmits data over a sidelink according to the resources allocated by the base station. The base station may allocate a resource for single transmission to the terminal, or may allocate resources for semi-persistent transmission to the terminal. As illustrated in FIG. 1A, the terminals are located within the network coverage, and the network allocates transmission resources for sidelink communication to the terminals.

In the second mode, a terminal selects a resource from a resource pool to perform data transmission. As illustrated in FIG. 1C, the terminal is located outside the cell coverage, and the terminal autonomously selects a transmission resource from a pre-configured resource pool to perform sidelink transmission, or as illustrated in FIG. 1A, the terminal autonomously selects a transmission resource from a resource pool configured by the network to perform sidelink transmission.

It is to be noted that, in embodiments of the disclosure, the first mode may also be referred to as a first resource selection mode or mode 1, and the second mode may also be referred to as a second resource selection mode or mode 2. The names of the first mode and the second mode are not limited in the technical solution of the embodiments of the disclosure.

### Transmission Mode in NR-V2X

Autonomous driving needs to be supported in the NR-V2X. Therefore, there are higher requirements for data interaction between vehicles, such as a higher throughput, a lower latency, a higher reliability, a larger coverage, and more flexible resource allocation.

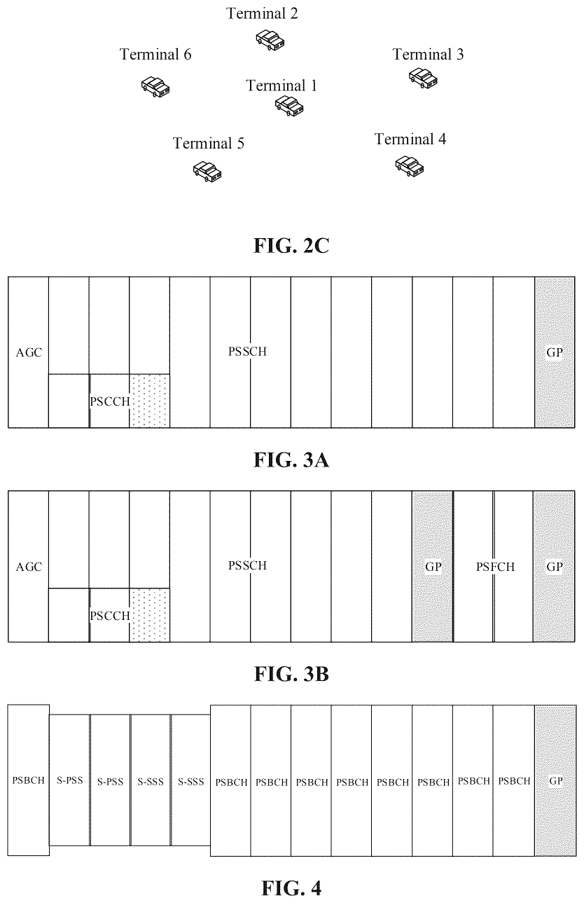

The broadcast transmission mode is supported in the LTE-V2X, and unicast and multicast transmission modes are introduced in the NR-V2X. There is only one terminal as a receiving end in the unicast transmission. As illustrated in FIG. 2A, unicast transmission is performed between the terminal 1 and the terminal 2. All terminals in a communication cluster or all terminals within a certain transmission distance are receiving ends in the multicast transmission. As illustrated in FIG. 2B, the terminal 1, the terminal 2, the terminal 3, and the terminal 4 form a communication cluster. The terminal 1 transmits data, and the other terminals in the cluster are all receiving ends. In the broadcast transmission mode, any terminal around the transmitting end is the receiving end. As illustrated in FIG. 2C, the terminal 1 is a transmitting end, and the other terminals around the terminal 1, namely the terminal 2 to the terminal 6, are all receiving ends.

### 2-Order Sidelink Control Information (SCI) Mechanism in NR-V2X

2-order SCI is introduced in the NR-V2X. The first-order SCI is carried in a Physical Sidelink Control Channel (PSCCH) for indicating a transmission resource, reserved resource information, a Modulation and Coding Scheme (MCS) level and a priority or the like of a Physical Sidelink Shared Channel (PSSCH). The second-order SCI is transmitted in a resource of the PSSCH and is demodulated using a Demodulation Reference Signal (DMRS) of the PSSCH, for indicating information for data demodulation such as a transmitter identifier (ID), a receiver ID, a Hybrid Automatic Repeat reQuest (HARQ) ID, and a New Data indicator (NDI).

### Frame Structure of NR-V2X System

Exemplarily, a slot structure in the NR-V2X is as illustrated in FIGS. 3-1 and 3-2. One slot includes 14 sidelink symbols. Each rectangular box in FIGS. 3-1 and 3-2 represents one sidelink symbol, and the sidelink symbol may be an Orthogonal Frequency Division Multiplexing (OFDM) symbol (which may also be referred to as a symbol for short).

FIG. 3A illustrates a slot structure including no Physical Sidelink Feedback Channel (PSFCH) in a slot. FIG. 3B illustrates a slot structure including a PSFCH in a slot. In FIGS. 3-1 and 3-2, a PSCCH occupies 2 or 3 symbols from the second sidelink symbol in the slot in the time domain, and may occupy {10, 12, 15, 20, 25} physical resource blocks (PRBs) in the frequency domain. In order to reduce the complexity of blind detection for the PSCCH by a terminal, only one number of PSCCH symbols and one number of PRBs are allowed to be configured in a resource pool. In addition, since a sub-channel is the minimum granularity of PSSCH resource allocation in the NR-V2X, the number of PRBs occupied by the PSCCH must be smaller than or equal to the number of PRBs contained in one sub-channel in the resource pool, so as to avoid additional restriction on PSSCH resource selection or allocation. The PSSCH also starts from the second sidelink symbol in the slot in the time domain. The last sidelink symbol in the slot is a Guard Period (GP) symbol, and the remaining symbols are mapped to the PSSCH. The first sidelink symbol in the slot is a repetition of the second sidelink symbol. Typically, a receiving end takes the first sidelink symbol as an Automatic Gain Control (AGC) symbol, and data on the AGC symbol is usually not used for data demodulation. The PSSCH occupies K (K≥1) sub-channels in the frequency domain, and each sub-channel includes N (N≥1) consecutive PRBs. In FIG. 3B, the slot contains a PSFCH. The second and third symbols to last in the slot are used for transmission of the PSFCH, and a symbol immediately previous to the PSFCH is used as a GP symbol.

### Sidelink Synchronization

A sidelink synchronization signal block (S-SSB) is described below.

In a sidelink system, a terminal may take a base station or the Global Navigation Satellite System (GNSS) as an original reference synchronization source. In addition, in order to ensure that sidelink communication can be performed normally under different coverage environments, the sidelink system can also take the terminal as a reference synchronization source. When the terminal is taken as a reference synchronization source, the terminal needs to transmit a Sidelink Synchronization Signal (SLSS) and a Physical Sidelink Broadcast Channel (PSBCH) to provide synchronization information and necessary sidelink configuration information for other terminals. In the sidelink system, the SLSS and the PSBCH are transmitted in a same slot, which is referred to as an S-SSB slot. The SLSS is divided into a sidelink primary synchronization signal (S-PSS) and a sidelink secondary synchronization signal (S-SSS). The structure of the S-SSB slot is as illustrated in FIG. 4. It is to be noted that each rectangular box in FIG. 4 represents one symbol. The S-PSS occupies 2 symbols, and the S-SSS occupies 2 symbols. The last symbol in the slot is used as a GP symbol, and the remaining symbols are used for transmission of the PSBCH.

The synchronization resource is described below.

After obtaining the synchronization information from the synchronization source, the terminal needs to transmit the sidelink synchronization signal and the PSBCH (i.e., the S-SSB) over the sidelink to assist other terminals in obtaining the synchronization information. The resource used for transmitting the sidelink synchronization signal and the PSBCH is referred to as a sidelink synchronization resource (referred to as a synchronization resource for short).

Due to the limitation of half-duplex, the terminal cannot receive a signal over a carrier while transmitting a signal over the carrier. In order to avoid loss of sidelink data since the terminal is unable to receive sidelink data from other terminals when transmitting the sidelink synchronization signal, the synchronization resource and the sidelink data transmission resource are multiplexed in Time-Division Multiplexing (TDM) in sidelink transmission, that is, Frequency-Division Multiplexing (FDM) is not supported for the S-SSB and the sidelink data. Specifically, the slot in which the synchronization resource is located is excluded when determining a resource pool for transmission of the sidelink data, that is, the slot in which the synchronization resource is located is not included in the resource pool. The slot in which the synchronization resource is located is also an S-SSB slot.

The period (which may also be referred to as a synchronization period) of a synchronization resource in the NR-V2X system is 160 ms, and the number of slots in one synchronization period is 160*2 \hat{ }μ, where μ=0, 1, 2, and 3 corresponding to subcarrier spacings of 15 kHz, 30 kHz, 60 kHz, and 120 kHz, respectively. Also, due to the limitation of half-duplex, the terminal needs to transmit and receive sidelink synchronization signals on different time-domain resources. Therefore, at least two sets of synchronization resources are configured in each synchronization period to transmit or receive S-SSBs respectively. When the GNSS has the highest priority in a carrier, a set of synchronization resources (i.e., a third set of synchronization resources) may be additionally configured on the carrier, in order to avoid mutual interference between an S-SSB transmitted by a terminal within a cell and an S-SSB transmitted by a terminal outside the cell. When a terminal which is located outside the network coverage and directly synchronized with GNSS transmits an S-SSB, the third set of synchronization resources will be used.

The beam-based sidelink transmission is not supported in the release-16 (R16) NR-V2X, but in order to improve the detection performance of an S-SSB, multiple transmission occasions are included in each set of synchronization resources, and the transmission occasions are used to transmit the S-SSB. If beam-based sidelink transmission is introduced in subsequent versions, a terminal may transmit an S-SSB using different beams in multiple transmission occasions.

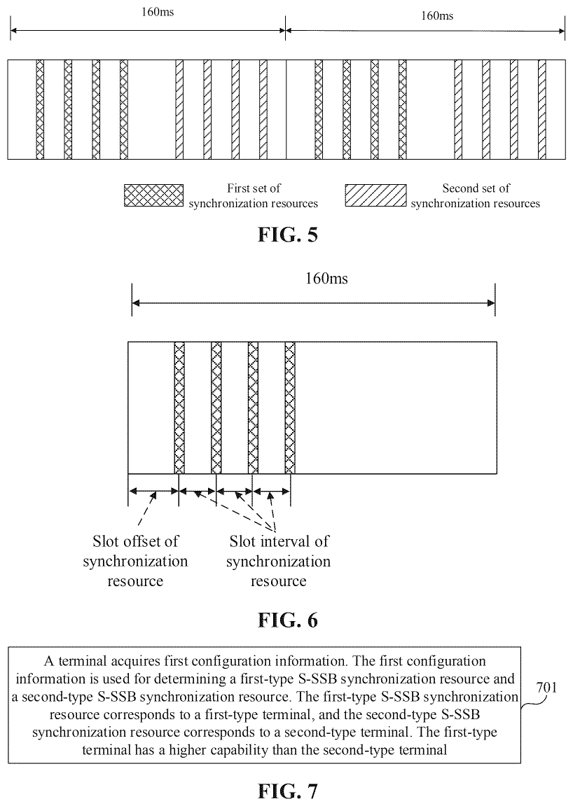

Exemplarily, FIG. 5 illustrates a schematic diagram of NR-V2X synchronization resources. A synchronization period is 160 ms, and two sets of synchronization resources are configured in each synchronization period, which are denoted as a first set of synchronization resources and a second set of synchronization resources. Four synchronization slots (i.e., four S-SSB slots or four transmission occasions) are configured in each set of synchronization resources, and a transmitting end can transmit an S-SSB on each of the four synchronization slots. When a sidelink synchronization signal is detected by a receiving end on a synchronization slot, the receiving end can determine whether the synchronization slot belongs to the first set of synchronization resources or the second set of synchronization resources according to a Direct Frame Number (DFN) and a slot number carried in a PSBCH transmitted simultaneously with the sidelink synchronization signal, and select four synchronization slots in another set of synchronization resources to transmit an S-SSB.

For any set of synchronization resources in the synchronization period, each synchronization slot (that is, a slot where a synchronization resource is located) in the set of synchronization resources can be determined by configuring the following three parameters.

The parameter 1 is the number (sl-NumSSB-WithinPeriod) of synchronization slots in the period. This parameter indicates the number of synchronization slots included in a set of synchronization resources in the synchronization period. Specifically, for different subcarrier spacings in FR1 and FR2, the number of synchronization slots in each set of synchronization resources may be determined referring to Table 1 below.

TABLE 1

| | FR1 | FR2 |
|---|---|---|
| 15 kHz SCS | {1} | |
| 30 kHz SCS | {1, 2} | |
| 60 kHz SCS | {1, 2, 4} | {1, 2, 4, 8, 16, 32} |
| 120 kHz SCS | | {1, 2, 4, 8, 16, 32, 64} |

The parameter 2 is a Synchronization slot offset (sl-TimeOffsetSSB). The parameter indicates a slot offset of the first synchronization resource in each set of synchronization resources in the synchronization period with respect to a boundary of the synchronization period.

The Parameter 3 is a Time interval (sl-TimeInterval). The parameter indicates a slot interval between two adjacent synchronization resources in each set of synchronization resources in the synchronization period.

The above three parameters may be configured by a network device, or may be agreed by a protocol, or may be predefined.

Exemplarily, FIG. 6 illustrates a set of synchronization resources in a synchronization period. The synchronization period is 160 ms, and the synchronization period includes 640 slots in case where a subcarrier spacing is 60 KHz. A set of synchronization resources is configured to contain four synchronization slots, that is, sl-NumSSB-WithinPeriod=4, the slot offset of the first synchronization resource in the set of synchronization resources with respect to a boundary of the period is 15 slots, that is, sl-TimeOffsetSSB=15, and the slot interval between two adjacent synchronization resources in the set of synchronization resources is 10 slots, that is, sl-TimeInterval=10. Thereby, it can be determined that the slots in which the four synchronization resources are located are slots 15, 25, 35 and 45 respectively.

In the current sidelink system, it is assumed that all terminals in the system have the same capability, such as supporting a same bandwidth, a same transmission power, and the like. Therefore, synchronization resources (including time-domain resources and frequency-domain resources) for transmitting/receiving S-SSBs are supported by all terminals. For example, if a synchronization period contains four synchronization slots, each terminal needs to try to transmit an S-SSB in the four synchronization slots. Also, in detecting/receiving the S-SSBs, the terminal assumes that S-SSBs are potentially transmitted in all synchronization slots, and thus will try to detect/receive S-SSBs in all the synchronization slots.

### Reduced-Capability Terminal

Reduced Capability (RedCap) is a 5th generation (5G) technology defined by the 3GPP. Compared with the 4th generation (4G), 5G has significant advantages in terms of a communication speed, a delay, reliability and the like, but also leads to an increase in design complexity and cost of the terminals. The high cost of the terminals is unacceptable in many actual commercial deployment scenarios. In these scenarios, the terminals have low requirements in communication performance and do not need to support the most powerful functions of 5G, but have high requirements in costs and power consumption. Therefore, in order to balance between performance and costs and to meet the needs of the industrial Internet and the Internet of Things for reduction in cost and power consumption, a reduced-capability terminal type is defined in the 3GPP Rel-17 version. The reduced-capability terminals can reduce the costs and power consumption by reducing a bandwidth, the number of antennas, and a modulation order.

The 3GPP Rel-18 SL project is promoting the standardization of deploying sidelink technologies in unlicensed frequency bands, that is, an SL-U technology. The SL-U technology can be deployed in commercial scenarios such as wearable smart devices, smart homes, and the industrial Internet. In discussion of the Rel-18 SL-U topic, all terminals have the same capability, but the reduced-capability terminal is not taken into account. However, the costs and power consumption of the terminals are very important indicators during commercial deployment. The low cost and low power consumption brought by the reduced-capability terminals can provide a convenient passage for commercialization of the SL-U technology. Therefore, standardization of the SL-U RedCap technology may be considered in Rel-19 SL.

During sidelink synchronization, a terminal needs to try to transmit S-SSBs in all synchronization slots in a synchronization period, however, if a reduced-capability terminal also tries to transmit S-SSBs in all synchronization slots in this way, the power consumption will be high. In addition, if the reduced-capability terminal is configured with the same synchronization resources (such as an S-SSB frequency-domain resource and an S-SSB time-domain resource) as a traditional terminal (which may also be referred to as a full-capability terminal, a strong-capability terminal, or the like), the complexity and power consumption of the reduced-capability terminal will be further increased. Therefore, the following technical solution of the embodiments of the disclosure is provided.

It is to be understood that the terms “system” and “network” herein are often used interchangeably. The term “and/or” herein merely describes a relation between associated objects, representing three relations. For example, A and/or B may represent following three cases: existence of A alone, existence of both A and B, and existence of B alone. Additionally, the character “/” generally indicates that the contextual objects are in an “or” relationship. It is also to be understood that “indicate” referred to in the embodiments of the disclosure may be direct indication or indirect indication, or may refer to that there is an association relationship. By way of example, “A indicates B” may refer to that A directly indicates B, for example B may be acquired through A. “A indicates B” may also refer to that A indirectly indicates B, for example, A indicates C and B may be acquired through C. “A indicates B” may also refer to that there is an association relationship between A and B. It is to be also understood that “correspond” referred to in the embodiments of the disclosure may mean that there is a direct correspondence or indirect correspondence between two objects, or may mean that there is an association relationship between the two objects, or may mean a relationship that one object indicates or is indicated by another object or a relationship that one object configures or is configured by another object. It also to be understood that “predefine” or “predefined rule” mentioned in the embodiments of the disclosure may be realized by codes or forms prestored in a device (for example, a terminal and a network device) or in other ways that can be used to indicate relevant information. The particular implementation is not limited in the disclosure. For example, “predefined” may refer to being defined in a protocol. It is also to be understood that, in the embodiments of the disclosure, the “protocol” may refer to standard protocols in the field of communications.

For convenience of understanding the technical solution of the embodiments of the disclosure, the technical solution of the disclosure will be described in detail via particular embodiments. The above relevant technologies may be as optional solutions combined with the technical solutions of the embodiments of the disclosure, and the combination shall fall within the scope of protection of the embodiments of the disclosure. The embodiments of the disclosure include at least part of the following content.

As a very important operation and step of the sidelink system, sidelink synchronization occurs before sidelink communication. In the technical solution of the embodiments of the disclosure, synchronization resources of an S-SSB are divided as two parts, one part being used for a first-type terminal having a high capability and the other part being used for a second-type terminal having a low capability, both terminals having different capabilities can be taken into account in the sidelink system, and it is ensured that the terminals having different capabilities can realize sidelink synchronization.

It is to be noted that a terminal capability or a capability of a terminal described in the embodiments of the disclosure may also be described as UE capability.

It is to be noted that, a synchronization resource described in the embodiments of the disclosure may also be described as a sidelink synchronization resource, and refers to a resource used for transmitting an S-SSB.

It is to be noted that a synchronization slot described in the embodiments of the disclosure refers to a slot in which a synchronization resource is located, that is, an S-SSB slot, or referred to as a transmission occasion for an S-SSB.

It is to be noted that a reduced-capability terminal described in the embodiments of the disclosure may also be described as a weak-capability terminal or RedCap UE.

It is to be noted that reception described in the embodiments of the disclosure may also be replaced with detection or monitoring in some cases.

FIG. 7 illustrates a schematic flowchart of a method for resource configuration according to the embodiments of the disclosure. As illustrated in FIG. 7, the method includes part or all of following operation.

At operation 701, a terminal acquires first configuration information. The first configuration information is used for determining a first-type sidelink synchronization signal block (S-SSB) synchronization resource and a second-type S-SSB synchronization resource. The first-type S-SSB synchronization resource corresponds to a first-type terminal, and the second-type S-SSB synchronization resource corresponds to a second-type terminal. The first-type terminal has a higher capability than the second-type terminal.

In the embodiments of the disclosure, the terminal is a terminal in a sidelink system. In some implementations, the sidelink system may be an SL-U system.

In some implementations, the terminal may be a first-type terminal, and the first-type terminal refers to a traditional terminal (which may also be referred to as a full-capability terminal, a strong-capability terminal, or the like). In some other implementations, the terminal may be a second-type terminal, and the second-type terminal refers to a reduced-capability terminal.

In embodiments of the disclosure, the first-type terminal has a higher capability than the second-type terminal. Exemplarily, capabilities of the terminal include: a transmission/reception bandwidth, a transmission power, an encoding and decoding capability, and the like. The reduced capability of the second-type terminal includes one or more of the following aspects: a transmission/reception bandwidth supported by the terminal is relatively small, the transmission power supported by the terminal is small, and the encoding and decoding capability supported by the terminal is low.

In embodiments of the disclosure, the first-type S-SSB synchronization resource refers to a synchronization resource used by the first-type terminal for transmitting/receiving an S-SSB. The second-type S-SSB synchronization resource refers to a synchronization resource used by the second-type terminal for transmitting/receiving an S-SSB. Here, a synchronization resource includes a time-domain resource and/or a frequency-domain resource.

In embodiments of the disclosure, the first-type S-SSB synchronization resource and the second-type S-SSB synchronization resource are configured by the first configuration information. In some implementations, the first configuration information is configured by a network. In some other implementations, the first configuration information is preconfigured.

In case that the first configuration information is configured by a network, a network device transmits the first configuration information, and accordingly, the terminal receives the first configuration information from the network device.

In some implementations, the first configuration information is carried in radio resource control (RRC) signaling. In some other implementations, the first configuration information is carried in a system broadcast message.

Exemplarily, the first configuration information may be referred to as a sidelink synchronization configuration (i.e.SL.-SyncConfig). Of course, the first configuration information may have other names, which is not limited in the disclosure.

In embodiments of the disclosure, the configuration of the first-type S-SSB synchronization resource and the second-type S-SSB synchronization resource may include a time-domain resource configuration, and optionally, may further include a frequency-domain resource configuration. The configurations in the two aspects are described below.

### Time-Domain Resource Configuration

In some implementations, a time-domain resource of the first-type S-SSB synchronization resource and a time-domain resource of the second-type S-SSB synchronization resource may be independently configured or may be unified-configured.

In Scheme 1, the time-domain resources are configured independently.

In some implementations, the first configuration information includes first time-domain configuration information and second time-domain configuration information. The first time-domain configuration information is used for determining a first-type synchronization slot(s), and the second time-domain configuration information is used for determining a second-type synchronization slot(s). The first-type synchronization slot corresponds to the first-type S-SSB synchronization resource, and the second-type synchronization slot corresponds to the second-type S-SSB synchronization resource.

Here, the first-type synchronization slot refers to a slot in which the first-type S-SSB synchronization resource is located. The first-type synchronization slot may also be referred to as a first-type S-SSB slot.

Here, the second-type synchronization slot refers to a slot in which the second-type S-SSB synchronization resource is located. The second-type synchronization slot may also be referred to as a second-type S-SSB slot.

The first-type synchronization slot and the second-type S-SSB slot are independently configured by the first time-domain configuration information and the second time-domain configuration information, respectively.

In some implementations, the first time-domain configuration information includes at least one of: a first parameter indicating a first synchronization period; a second parameter indicating the number of first-type synchronization slots included in the first synchronization period; a third parameter indicating a slot offset of the first first-type synchronization slot in the first synchronization period with respect to a boundary of the first synchronization period; or a fourth parameter indicating a slot interval between two adjacent first-type synchronization slots within the first synchronization period.

Exemplarily, the second parameter may be the number (sl-NumSSB-WithinPeriod) #1 of synchronization slots in the period. The third parameter may be a synchronization slot offset (sl-TimeOffsetSSB) #1. The fourth parameter may be a time interval (sl-TimeInterval) #1.

The time-domain position (that is, the slot position in which the first-type S-SSB synchronization resource is located) of each first-type synchronization slot in the first synchronization period may be determined by the first time-domain configuration information.

Exemplarily, for different subcarrier spacings in FR1 and FR2, the number of first-type synchronization slots included in the first synchronization period may be determined referring to Table 1 above.

In some implementations, the second time-domain configuration information includes at least one of: a fifth parameter indicating a second synchronization period; a sixth parameter indicating the number of second-type synchronization slots included in the second synchronization period; a seventh parameter indicating a slot offset of the first second-type synchronization slot in the second synchronization period with respect to a boundary of the second synchronization period; or an eighth parameter indicating a slot interval between two adjacent second-type synchronization slots in the second synchronization period.

Exemplarily, the sixth parameter may be the number (sl-NumSSB-WithinPeriod) #2 of synchronization slots in the period. The seventh parameter may be a synchronization slot offset (sl-TimeOffsetSSB) #2. The eighth parameter may be a time interval (sl-TimeInterval) #2.

Exemplarily, for different subcarrier spacings in FR1 and FR2, the number of second-type synchronization slots included in the second synchronization period may be determined referring to Table 2 below.

TABLE 2

| | FR1 | FR2 |
|---|---|---|
| 15 kHz SCS | {1, 2} | |
| 30 kHz SCS | {1, 2, 4} | |
| 60 kHz SCS | {1, 2, 4, 6, 8} | {1, 2, 4, 6, 8, 10} |
| 120 kHz SCS | | {1, 2, 4, 6, 8, 10, |
| | | 16, 20, 32, 40, 64, 80} |

The time-domain position (that is, the slot position in which the second-type S-SSB synchronization resource is located,) of each second-type synchronization slot in the second synchronization period can be determined by the second time-domain configuration information.

It is to be noted that, the parameters configured by the first time-domain configuration information may have identical values with or different values from the parameters configured by the second time-domain configuration information.

In some implementations, the first synchronization period configured by the first time-domain configuration information is same as the second synchronization period configured by the second time-domain configuration information. In some other implementations, the first synchronization period configured by the first time-domain configuration information is different from the second synchronization period configured by the second time-domain configuration information.

Here, the case that the first synchronization period is the same as the second synchronization period may be include that the length of the first synchronization period is the same as the length of the second synchronization period, and a starting boundary of the first synchronization period is aligned with a starting boundary of the second synchronization period.

Here, the case that the first synchronization period is different from the second synchronization period may include that the length of the first synchronization period is different from the length of the second synchronization period, and/or a starting boundary of the first synchronization period is not aligned with a starting boundary of the second synchronization period.

In some implementations, the length of the first synchronization period is L times the length of the second synchronization period, L being an integer greater than 1. The starting boundary of the first synchronization period is aligned with the starting boundary of L second synchronization periods.

In Scheme 2: time-domain resources are unified-configured.

In some implementations, the first configuration information includes third time-domain configuration information and first information. The third time-domain configuration information and the first information are used for determining a first-type synchronization slot(s) and a second-type synchronization slot(s). The first-type synchronization slot corresponds to the first-type S-SSB synchronization resource, and the second-type synchronization slot corresponds to the second-type S-SSB synchronization resource.

Here, the first-type synchronization slot refers to a slot in which the first-type S-SSB synchronization resource is located. The first-type synchronization slot may also be referred to as a first-type S-SSB slot.

Here, the second-type synchronization slot refers to a slot in which the second-type S-SSB synchronization resource is located. The second-type synchronization slot may also be referred to as a second-type S-SSB slot.

The first-type synchronization slot and the second-type S-SSB slot are unified-configured by the third time-domain configuration information and the first information.

In some implementations, the third time-domain configuration information includes at least one of: a ninth parameter indicating a third synchronization period; a tenth parameter indicating the number of synchronization slots included in the third synchronization period; an eleventh parameter indicating a slot offset of the first synchronization slot in the third synchronization period with respect to a boundary of the third synchronization period; or a twelfth parameter indicating a slot interval between two adjacent synchronization slots in the third synchronization period.

Exemplarily, the tenth parameter may be the number (sl-NumSSB-WithinPeriod) #3 of synchronization slots in the period. The eleventh parameter may be a synchronization slot offset (sl-TimeOffsetSSB) #3. The twelfth parameter may be a time interval (sl-TimeInterval) #3.

Exemplarily, for different subcarrier spacings in FR1 and FR2, T the number of third-type synchronization slots included in the third synchronization period may be determined referring to Table below.

TABLE 3

| | FR1 | FR2 |
|---|---|---|
| 15 kHz SCS | {1, 2, 4, 6, 8} | |
| 30 kHz SCS | {1, 2, 4, 6, 8, 10, | |
| | 16, 20} | |
| 60 kHz SCS | {1, 2, 4, 6, 8, 10, | {1, 2, 4, 6, 8, 10, 16, |
| | 16, 20, 32, 40} | 20, 32, 40, 64, 80} |
| 120 kHz SCS | | {1, 2, 4, 6, 8, 10, 16, 20, |
| | | 32, 40, 64, 80, 128, 140} |

The time-domain position (that is, the slot position in which the synchronization resource is located) of each synchronization slot in the third synchronization period may be determined by the third time-domain configuration information.

A case that the first-type synchronization slot overlap with the second-type synchronization slot is described below.

In some implementations, all synchronization slots configured by the third time-domain configuration information are the first-type synchronization slot, and a first portion of synchronization slots configured by the third time-domain configuration information are the second-type synchronization slot, and the first portion of synchronization slots are indicated by the first information.

Here, the first-type synchronization slot is configured by the third time-domain configuration information, and a portion of synchronization slots among the first-type synchronization slots is the second-type synchronization slot. That is, the portion of synchronization slots belongs to both the first-type synchronization slot and the second-type synchronization slot, and the portion of synchronization slots are indicated by the first information.

There may be following schemes for indicating the first portion of synchronization slots by the first information.

In Scheme 1-1, in some implementations, the first information indicates the number N of synchronization slots contained in the first portion of synchronization slots.

Here, it is agreed by default or by the protocol that the first portion of synchronization slots include the last N synchronization slots among all the synchronization slots; or that the first portion of synchronization slots include the first N synchronization slots among all the synchronization slots.

Exemplarily, the third time-domain configuration information configures that P synchronization slots in the third synchronization period belong to the first-type synchronization slot, and the first information indicates that N synchronization slots among the P synchronization slots belong to the second-type synchronization slot. It is agreed by default or by the protocol that last/the first N synchronization slots among the P synchronization slots belong to the second-type synchronization slot.

In Scheme 1-2, in some implementations, the first information includes a first bitmap. P bits in the first bitmap have a correspondence relationship with P synchronization slots. The P synchronization slots are all the synchronization slots. A value of each bit indicates whether a synchronization slot corresponding to the respective bit belongs to the first portion of synchronization slots.

Exemplarily, the third time-domain configuration information configures that P synchronization slots in the third synchronization period belong to first-type synchronization slots, and the P bits in the first bitmap indicates that which slots in the P synchronization slots belongs to second-type synchronization slots. The P bits have a correspondence relationship with the P synchronization slots. The value 1 of a bit 1 indicates that a synchronization slot corresponding to the bit belongs to the second-type synchronization slot, and the value 0 of a bit indicates that a synchronization slot corresponding to the bit does not belong to the second-type synchronization slot. Alternatively, the value 0 of a bit indicates that a synchronization slot corresponding to the bit belongs to the second-type synchronization slot, and the value 1 of a bit indicates that a synchronization slot corresponding to the bit does not belong to the second-type synchronization slot

In scheme 1-3, in some implementations, the first information includes a first pattern index indicating a first pattern of multiple patterns, and each pattern of the multiple patterns corresponds to a respective synchronization slot pattern to which the first portion of synchronization slots correspond.

Exemplarily, the third time-domain configuration information configures that P synchronization slots in the third synchronization period belong to the first-type synchronization slots. Multiple patterns are preconfigured, and each pattern of the multiple patterns corresponds to a synchronization slot pattern. The synchronization slot pattern may also be considered as a pattern that the P synchronization slots belong to the second-type synchronization slots. The pattern of the second-type synchronization slots may be described by slot indexes of the second-type synchronization slots or in a manner similar to the first bitmap. Each pattern corresponds to a pattern index, and the pattern indicated by a pattern index (i.e. the first pattern index) can determine that which synchronization slot(s) among the P synchronization slots belongs to the second-type synchronization slots.

A case that the first-type synchronization slot does not overlap with the second-type synchronization slot is described below.

In some implementations, a second portion of synchronization slots configured by the third time-domain configuration information are the first-type synchronization slots, and the first portion of synchronization slots configured by the third time-domain configuration information are the second-type synchronization slots. The first portion of synchronization slots and/or the second portion of synchronization slots are indicated by the first information.

Here, two portions of synchronization slots are configured by the third time-domain configuration information. The first portion of synchronization slot belongs to the second-type synchronization slots, and the second portion of synchronization slots belongs to the first-type synchronization slots. The first indication may indicate that which portion of synchronization slots belongs to the first-type synchronization slot and/or which portion of the synchronization slots belongs to the second-type synchronization slot.

There may be following schemes for indicating the first portion of synchronization slots and/or the second portion of synchronization slots by the first information.

In scheme 2-1, in some implementations, the first information indicates the number N of synchronization slots contained in the first portion of synchronization slots and/or the number M of synchronization slots contained in the second portion of synchronization slots.

Here, it is agreed by default or by a protocol that: the first portion of synchronization slots include the last N synchronization slots among all the synchronization slots, and the second portion of synchronization slots include the first M synchronization slots among all the synchronization slots; or the first portion of synchronization slots include the first N synchronization slots among all the synchronization slots, and the second portion of synchronization slots include the last M synchronization slots among all the synchronization slots.

Exemplarily, P synchronization slots in the third synchronization period are configured by the third time-domain configuration information, and the first information indicates that N synchronization slots among the P synchronization slots belong to second-type synchronization slots and/or M synchronization slots among the P synchronization slots belong to first-type synchronization slots. It is agreed by default or by a protocol that: the last/first N synchronization slots among the P synchronization slots belong to second-type synchronization slots, and the first/last M synchronization slots among the P synchronization slots belong to second-type synchronization slots.

In scheme 2-2, in some implementations, the first information includes a second bitmap. P bits in the second bitmap have a correspondence relationship with P synchronization slots. The P synchronization slots include the first portion of synchronization slots and the second portion of synchronization slots. A value of each bit indicates whether a synchronization slot corresponding to the bit belongs to the first portion of synchronization slots or the second portion of synchronization slots.

Exemplarily, the P synchronization slots in the third synchronization period are configured by the third time-domain configuration information, and the P bits in the second bitmap indicates that which slots of the P synchronization slots belong to the first-type synchronization slots and which slots of the P synchronization slots belong to the second-type synchronization slots. The P bits have a correspondence relationship with the P synchronization slots. The value 1 of a bit indicates that a synchronization slot corresponding to the slot belongs to the second-type synchronization slot, and a value 0 of a bit indicates that a synchronization slot corresponding to the slot belongs to the first-type synchronization slot. Alternatively, the value 0 of a bit indicates that a synchronization slot corresponding to the slot belongs to the second-type synchronization slot, and a value 1 of a bit indicates that a synchronization slot corresponding to the slot belongs to the first-type synchronization slot.

In scheme 2-3, in some implementations, the first information includes a second pattern index indicating a second pattern of multiple patterns, and each pattern of the multiple patterns corresponds to a synchronization slot pattern to which the first portion of synchronization slots and the second portion of synchronization slots correspond.

Exemplarily, P synchronization slots in the third synchronization period are configured by the third time-domain configuration information. Multiple patterns are preconfigured, and each pattern of the multiple patterns corresponds to a synchronization slot pattern. The synchronization slot pattern may also be considered as a pattern that the P synchronization slots belong to first-type synchronization slots and second-type synchronization slots. The pattern of first-type synchronization slots and second-type synchronization slots may be described by slot indexes of the first-type synchronization slots and the second-type synchronization slots or in a manner similar to the second bitmap. Each pattern corresponds to a pattern index, the pattern indicated by a pattern index (i.e. the first pattern index) may determine that which synchronization slot(s) among the P synchronization slots belongs to the first-type synchronization slots and which synchronization slot(s) among the P synchronization slots belongs to the second-type synchronization slots.

The following configuration can be realized according to the above scheme 1: two synchronization periods (a first synchronization period T1 and a second synchronization period T2) are configured in the sidelink system. P1 (P1≥1) first-type synchronization slots (which may also be referred to as first-type S-SSB time-domain resources) are configured in the first synchronization period T1, and P2 (P2>0) second-type synchronization slots (which may also be referred to as second-type S-SSB time-domain resources) are configured in the second synchronization period T2. The length of the second synchronization period T2 may be equal to the length of the first synchronization period T1, and a starting boundary of the second synchronization period T2 is aligned with a starting boundary of the first synchronization period T1. Alternatively, the length of the second synchronization period T2 may be different from the length of the first synchronization period T1. In an implementation, T2=L×T1, that is, the length of the second synchronization period T2 is L times the length of the first synchronization period T1, and a starting boundary of the second synchronization period T2 is aligned with a starting boundary of L first synchronization periods T1.

The following configuration can be realized according to the above scheme 2: one synchronization period (that is, a third synchronization period T3) is configured in the sidelink system. D (D≥1) first-type synchronization slots (which may also be referred to as first-type S-SSB time-domain resources) are configured in the third synchronization period T3, and P4 (P4≥1) synchronization slots among the D first-type synchronization slots are configured as second-type synchronization slots (which may also be referred to as second-type S-SSB time-domain resources). Alternatively, P3 (P3≥1) first-type synchronization slots (which may also be referred to as first-type S-SSB time-domain resources) and P4 (P4≥1) second-type synchronization slots (which may also be referred to as second-type S-SSB time-domain resources) are configured in the third synchronization period T3.

Of course, the effect of the configuration achieved by scheme 2 can also be realized in scheme 1, as long as the two synchronization periods are configured to be the same synchronization period, and the positions of the synchronization slots configured in each synchronization period in scheme 2 are consistent with the positions of the synchronization slots configured in scheme 2.

### Frequency-Domain Resource Configuration

In some implementations, a frequency-domain resource of the first-type S-SSB synchronization resource and a frequency-domain resource of the second-type S-SSB synchronization resource may be independently configured or may be unified-configured.

In Scheme A, frequency-domain resources are configured independently.

In some implementations, the first configuration information further includes first frequency-domain configuration information and second frequency-domain configuration information. The first frequency-domain configuration information is used for determining a first-type S-SSB frequency-domain resource, and the second frequency-domain configuration information is used for determining a second-type S-SSB frequency-domain resource. The first-type S-SSB frequency-domain resource corresponds to the first-type S-SSB synchronization resource, and the second-type S-SSB frequency-domain resource corresponds to the second-type S-SSB synchronization resource.

Here, the first-type S-SSB frequency-domain resource refers to a frequency-domain resource in which the first-type S-SSB synchronization resource is located or a frequency-domain resource corresponding to the first-type synchronization slot.

Here, the second-type S-SSB frequency-domain resource refers to a frequency-domain resource in which the second-type S-SSB synchronization resource is located or a frequency-domain resource corresponding to the second-type synchronization slot.

The first-type S-SSB frequency-domain resource and the second-type S-SSB frequency-domain resource are independently configured by the first frequency-domain configuration information and the second frequency-domain configuration information respectively.

In some implementations, the first frequency-domain configuration information is used for configuring the first-type S-SSB frequency-domain resource for one or more frequency bands; and the second frequency-domain configuration information is used for configuring the second-type S-SSB frequency-domain resources for one or more frequency bands.

Exemplarily, the following configuration may be realized by the first frequency-domain configuration information: K1 (K1≥1) first-type S-SSB frequency-domain resources are configured in the first frequency band; and K2 (K2≥1) first-type S-SSB frequency-domain resources are configured in the second frequency band. The following configuration can be realized by the second frequency-domain configuration information: K3 (K3≥1) second-type S-SSB frequency-domain resources are configured in the first frequency band; and K4 (K4≥1) second-type S-SSB frequency-domain resources are configured in the second frequency band. The values of K1, K2, K3, and K4 are independently configured, and may be same with each other, or may be different.

It is to be noted that, the frequency band in which the first-type S-SSB frequency-domain resource is located may be the same as, or different from or partially the same as the frequency band in which the second-type S-SSB frequency-domain resource is located.

In the above scheme, since the first-type S-SSB frequency-domain resource and the second-type S-SSB frequency-domain resource are independently configured, the resource occupied by the first-type S-SSB frequency-domain resource in the frequency domain may be different from or the same as the resource occupied by the second-type S-SSB frequency-domain resource in the frequency domain. Here, the resource occupied in the frequency domain may include following aspects: the number of S-SSB frequency-domain resources, the number and positions of resource blocks (RBs) occupied by each S-SSB frequency-domain resource.

In Scheme B, frequency-domain resources is unified-configured.

In some implementations, the first configuration information further includes third frequency-domain configuration information. The third frequency-domain configuration information is used for determining a first-type S-SSB frequency-domain resource and a second-type S-SSB frequency-domain resource. The first-type S-SSB frequency-domain resource corresponds to the first-type S-SSB synchronization resource, and the second-type S-SSB frequency-domain resource corresponds to the second-type S-SSB synchronization resource.

Here, the first-type S-SSB frequency-domain resource refers to a frequency-domain resource in which the first-type S-SSB synchronization resource is located or a frequency-domain resource corresponding to the first-type synchronization slot.

Here, the second-type S-SSB frequency-domain resource refers to a frequency-domain resource in which the second-type S-SSB synchronization resource is located or a frequency-domain resource corresponding to the second-type synchronization slot.

The first-type S-SSB frequency-domain resource and the second-type S-SSB frequency-domain resource are unified-configured by the third frequency-domain configuration information.

In some implementations, the third frequency-domain configuration information is used for configuring the first-type S-SSB frequency-domain resource and the second-type S-SSB frequency-domain resource for one or more frequency bands.

Exemplarily, the frequency band described above may include, but is not limited to: a carrier, a Bandwidth Part (BWP), a sidelink BWP (SL BWP), a channel, a resource pool, an RB set, a frequency range, and the like.

In the above scheme, since the first-type S-SSB frequency-domain resource and the second-type S-SSB frequency-domain resource are unified-configured, the resource occupied by the first-type S-SSB frequency-domain resource in the frequency domain is same as the resource occupied by the second-type S-SSB frequency-domain resource in the frequency domain. Here, the resource occupied in the frequency domain may include one or more of following aspects: the number of S-SSB frequency-domain resources, the number and positions of resource blocks (RBs) occupied by each S-SSB frequency-domain resource.

In the embodiments of the disclosure, the first-type S-SSB frequency-domain resource has a mapping relationship with the first-type synchronization slot, and the second-type S-SSB frequency-domain resource has a mapping relationship with the second-type synchronization slot. That is, the first-type S-SSB frequency-domain resource is mapped into the first-type synchronization slot, and the second-type S-SSB frequency-domain resource is mapped into the second-type synchronization slot. It can be understood that the first-type S-SSB synchronization resource is mapped to the first-type synchronization slot in the time domain, and is mapped to the first-type S-SSB frequency-domain resource in the frequency domain. Similarly, the second-type S-SSB synchronization resource is mapped to the second-type synchronization slot in the time domain, and is mapped to the second-type S-SSB frequency-domain resource in the frequency domain.

In some implementations, in case that the terminal is the first-type terminal, the first-type terminal transmits or receives an S-SSB on the first-type S-SSB synchronization resource, or the first-type terminal transmits or receives an S-SSB on the first-type S-SSB synchronization resource and the second-type S-SSB synchronization resource.

Here, the first-type S-SSB synchronization resource may refer to a first-type synchronization slot and/or a first-type S-SSB frequency-domain resource.

Here, the type of S-SSB synchronization resource on which the first-type terminal receives the S-SSB is related to an object with which the first-type terminal communicates. If the first-type terminal communicates with another first-type terminal, the first-type terminal may receive an S-SSB on the first-type S-SSB synchronization resource. If the first-type terminal communicates with one or more other terminals (including a second-type terminal), the first-type terminal may receive an S-SSB on both the first-type S-SSB synchronization resource and the second-type S-SSB synchronization resource.

In some implementations, the first-type terminal transmits or receives an S-SSB on a part of the first-type S-SSB synchronization resource. In some other implementations, the first-type terminal transmits or receives an S-SSB on all of the first-type S-SSB synchronization resource.

Here, the part of the first-type S-SSB synchronization resource described above may be considered as a default/mandatory synchronization resource. The first-type terminal transmits or receives an S-SSB on this part of resource instead of all the resource, thereby reducing power consumption of the terminal. Optionally, the first-type terminal may also transmit or receive an S-SSB on the remaining part of resource.

In some implementations, the part of the first-type S-SSB synchronization resource includes a part of first-type synchronization slots corresponding to the first-type S-SSB synchronization resource and/or a part of first-type S-SSB frequency-domain resources corresponding to the first-type S-SSB synchronization resource.

Here, the part of first-type synchronization slots corresponding to the first-type S-SSB synchronization resource may be considered as a default/mandatory synchronization slot(s). The part of the first-type S-SSB frequency-domain resource corresponding to the first-type S-SSB synchronization resource may be considered as a default/mandatory S-SSB frequency-domain resource. The first-type terminal transmits or receives an S-SSB on the part of first-type synchronization slots and/or the part of the first-type S-SSB frequency-domain resource rather than all of the first-type synchronization slots and/or all of the first-type S-SSB frequency-domain resource, thereby reducing power consumption of the terminal. Optionally, the first-type terminal may also transmit or receive an S-SSB on the remaining part of resource.

In some implementations, in case that the terminal is the second-type terminal, the second-type terminal transmits or receives an S-SSB on the second-type S-SSB synchronization resource, or the first-type terminal transmits or receives an S-SSB on the second-type S-SSB synchronization resource and the first-type S-SSB synchronization resource.

Here, the type of S-SSB synchronization resource on which the second-type terminal receives an S-SSB is related to an object with which the second-type terminal communicates. If the second-type terminal communicates with another second-type terminal, the second-type terminal may receive an S-SSB on the second-type S-SSB synchronization resource. If the second-type terminal communicates with one or more other terminals (including a first-type terminal), the second-type terminal may receive an S-SSB on both the first-type S-SSB synchronization resource and the second-type S-SSB synchronization resource.

Here, the second-type S-SSB synchronization resource may refer to a second-type synchronization slot and/or a second-type S-SSB frequency-domain resource.

In some implementations, the second-type terminal transmits or receives an S-SSB on a part of the second-type S-SSB synchronization resource; or the second-type terminal transmits or receives an S-SSB on all of the second-type S-SSB synchronization resource.

Here, the part of the second-type S-SSB synchronization resource described above may be considered as a default/mandatory synchronization resource. The second-type terminal transmits or receives the S-SSB on this part of resource instead of all of the resource, thereby reducing power consumption of the terminal. Optionally, the second-type terminal may also transmit or receive an S-SSB on the remaining part of resource.

In some implementations, the part of the second-type S-SSB synchronization resource includes a part of second-type synchronization slots corresponding to the second-type S-SSB synchronization resource and/or a part of a second-type S-SSB frequency-domain resource corresponding to the second-type S-SSB synchronization resource.

Here, the part of second-type synchronization slots corresponding to the second-type S-SSB synchronization resource may be considered as a default/mandatory synchronization slot(s). The part of the second-type S-SSB frequency-domain resource corresponding to the second-type S-SSB synchronization resource may be considered as a default/mandatory S-SSB frequency-domain resource. The second-type terminal transmits or receives an S-SSB on the part of second-type synchronization slots and/or the part of the second-type S-SSB frequency-domain resource instead of all of the second-type synchronization slots and/or all of the second-type S-SSB frequency-domain resource, thereby reducing power consumption of the terminal. Optionally, the second-type terminal may also transmit or receive an S-SSB on the remaining part of resource.

In the above scheme, if the synchronization resource is a resource in an unlicensed frequency band, the terminal needs to perform Listen Before Talk (LBT) before transmitting an S-SSB, and can transmit the S-SSB on an S-SSB synchronization resource only when it is determined, based on an LBT result, that the S-SSB synchronization resource is not occupied.

It is to be noted that, the first-type S-SSB synchronization resource may include two sets of synchronization resources. One set of synchronization resources is used by the first-type terminal to transmit an S-SSB, and the other set of synchronization resources is used by the first-type terminal to receive an S-SSB. Accordingly, the configuration of the first-type S-SSB synchronization resource may include two configurations corresponding to the two sets of synchronization resources, and reference may be made to the configuration schemes above.

It is to be noted that, the second-type S-SSB synchronization resource may include two sets of synchronization resources. One set of synchronization resources is used by the second-type terminal to transmit an S-SSB, and the other set of synchronization resources is used by the second-type terminal to receive an S-SSB. Accordingly, the configuration of the second-type S-SSB synchronization resource may include two configurations corresponding to the two sets of synchronization resources, and reference may be made to the configuration schemes above.

According to the technical solution of the embodiments of the disclosure, a method for sidelink synchronization resource configuration is proposed. An additional dedicated S-SSB synchronization resource (that is, the second-type S-SSB synchronization resource) is configured for the reduced-capability terminal (that is, the second-type terminal). The additional dedicated S-SSB synchronization resource may be different from the S-SSB synchronization resource (that is, the first-type S-SSB synchronization resource) corresponding to the terminal (that is, the first-type terminal) with a high capability. In addition, the reduced-capability terminal (that is, the second-type terminal) does not need to transmit or receive an S-SSB on all the S-SSB synchronization resource, but can transmit or receive an S-SSB on the default/mandatory S-SSB synchronization resource, thereby effectively reducing power consumption. The technical solution of the embodiments of the disclosure greatly reduces the power consumption and processing complexity of the reduced-capability terminal in transmitting or receiving the S-SSB, thereby saving power for the reduced-capability terminal without complex hardware design. Also, it can also ensure that the reduced-capability terminal and the strong-capability terminal coexist on the same resources and achieve interconnection, for providing a good solution for the interconnection and intercommunication of multiple devices (terminals with different capabilities) in the future intelligent Internet of Things.

The technical solution according to the embodiments of the disclosure is described by way of example hereinafter in conjunction with particular application examples.

### First Application Example

In this application example, a time-domain resource (that is, an S-SSB time-domain resource) corresponding to the first-type S-SSB synchronization resource and a time-domain resource (that is, an S-SSB time-domain resource) corresponding to the second-type S-SSB synchronization resource may be independently configured or may be unified-configured. Regarding the configuration manner of independent configuration, reference may be made to scheme 1 (independent configuration of time-domain resources) in the solution of FIG. 7. Regarding the configuration manner of unified configuration, reference may be made to scheme 2 (unified configuration of time-domain resources) in the solution of FIG. 7. The first-type S-SSB synchronization resource and the second-type S-SSB synchronization resource share a same synchronization period.

Exemplarily, as illustrated in FIG. 8, four first-type S-SSB slots (i.e., four first-type synchronization slots) and two second-type S-SSB slots (i.e., four second-type synchronization slots) are configured in one synchronization period. There is no overlap between the four first-type S-SSB slots and the two second-type S-SSB slots.

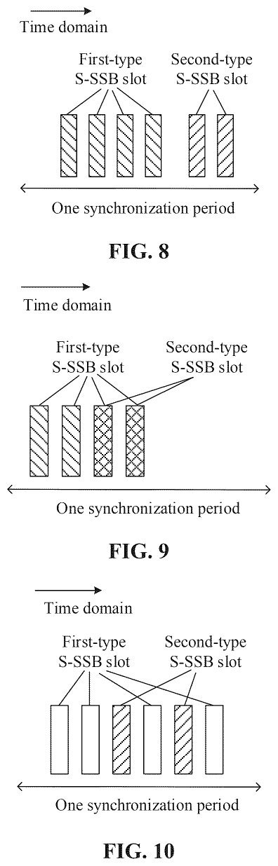

Exemplarily, as illustrated in FIG. 9, four S-SSB slots (that is, synchronization slots) are configured in one synchronization period. The four S-SSB slots belong to the first-type S-SSB slots (that is, first-type synchronization slots), and the last two S-SSB slots among the four S-SSB slots also belong to the second-type S-SSB slots (that is, second-type synchronization slots). That is, there is an overlap between the four first-type S-SSB slots and the two second-type S-SSB slots.

Exemplarily, as illustrated in FIG. 10, six S-SSB slots (that is, synchronization slots) are configured in one synchronization period. Among the six S-SSB slots, four S-SSB slots belong to the first-type S-SSB slots (that is, first-type synchronization slots), and the other two S-SSB slots belong to the second-type S-SSB slots (that is, second-type synchronization slots).

When a second-type terminal (that is, a reduced-capability terminal) transmits an S-SSB in the second-type S-SSB slots, the second-type terminal may select a portion of second-type S-SSB slots from the second-type S-SSB slots, to transmit the S-SSB on the portion of second-type S-SSB slots, to reduce power consumption. This portion of S-SSB slots may be a default/mandatory S-SSB slot(s) configured by a network, or preconfigured, or agreed in a protocol.

The second-type terminal (i.e., a reduced-capability terminal) receives an S-SSB on the second-type S-SSB slots. Optionally, the second-type terminal may also receive an S-SSB on the first-type S-SSB slot. Here, the type of S-SSB synchronization slot on which the second-type terminal receives an S-SSB is related to an object with which the second-type terminal communicates. If the second-type terminal communicates with another second-type terminal, the second-type terminal may receive the S-SSB on the second-type S-SSB synchronization slot. If the second-type terminal communicates with one or more other terminals (including a first-type terminal), the second-type terminal may receive an S-SSB on both the first-type S-SSB synchronization slot and the second-type S-SSB synchronization slot.

### Second Application Example

In this application example, a time-domain resource (that is, an S-SSB time-domain resource) corresponding to the first-type S-SSB synchronization resource and a time-domain resource (that is, an S-SSB time-domain resource) corresponding to the second-type S-SSB synchronization resource may be independently configured. Regarding the configuration manner of independent configuration, reference may be made to scheme 1 (independent configuration of time-domain resources) in the solution of FIG. 7. A synchronization period of the first-type S-SSB synchronization resource is a first synchronization period T1, and a synchronization period of the second-type S-SSB synchronization resource is a second synchronization period T2.

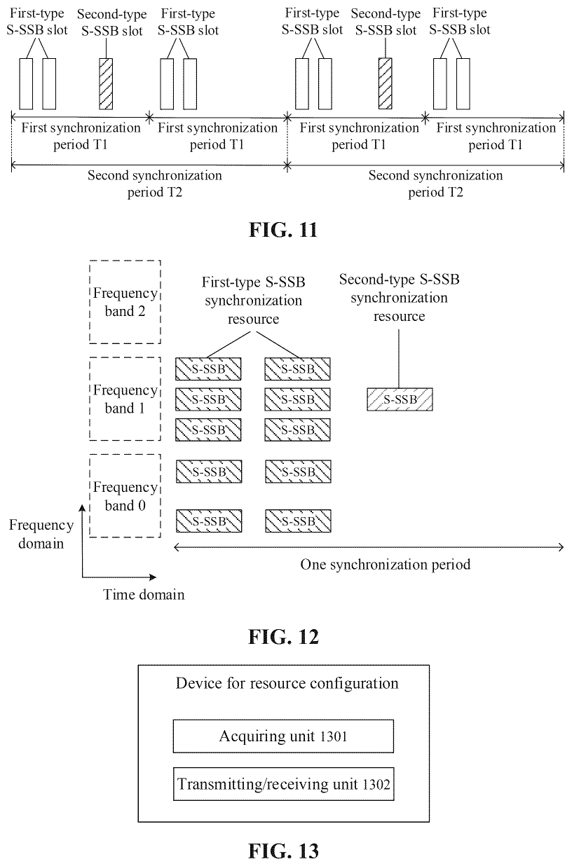

Exemplarily, as illustrated in FIG. 11, there is a proportional relationship between the first synchronization period T1 and the second synchronization period T2. Here, description is made by taking T2=2×T1 as an example. The starting boundary of the second synchronization period T2 is aligned with the starting boundary of the two first synchronization periods T1. Two first-type S-SSB slots (i.e., two first-type synchronization slots) are configured in the first synchronization period T1, and one second-type S-SSB slot (i.e., one second-type synchronization slot) is configured in the second synchronization period T2.

A second-type terminal (i.e., a reduced-capability terminal) receives an S-SSB on the second-type S-SSB slot. Optionally, the second-type terminal may also receive an S-SSB on the first-type S-SSB slot. Here, the type of S-SSB synchronization slot on which the second-type terminal receives an S-SSB is related to an object with which the second-type terminal communicates. If the second-type terminal communicates with another second-type terminal, the second-type terminal may receive an S-SSB on the second-type S-SSB synchronization slot. If the second-type terminal communicates with one or more other terminals (including the first-type terminal), the second-type terminal may receive the S-SSB on both the first-type S-SSB synchronization slot and the second-type S-SSB synchronization slot.

### Third Application Example

In this application example, a time-domain resource (that is, an S-SSB time-domain resource) corresponding to the first-type S-SSB synchronization resource and a time-domain resource (that is, an S-SSB time-domain resource) corresponding to the second-type S-SSB synchronization resource may be independently configured or may be unified-configured. Regarding the configuration manner of independent configuration, reference may be made to scheme 1 (independent configuration of time-domain resources) in the solution of FIG. 7. Regarding the configuration manner of unified configuration, reference may be made to scheme 2 (unified configuration of time-domain resources) in the solution of FIG. 7. A frequency-domain resource (that is, an S-SSB frequency-domain resource) corresponding to the first-type S-SSB synchronization resource and a frequency-domain resource (that is, an S-SSB frequency-domain resource) corresponding to the second-type S-SSB synchronization resource may be independently configured or may be unified-configured. Regarding the configuration manner of independent configuration, reference may be made to scheme A (independent configuration of frequency-domain resources) in the solution of FIG. 7. Regarding the configuration manner of unified configuration, reference may be made to scheme B (unified configuration of frequency-domain resources) in the solution of FIG. 7.

Exemplarily, as illustrated in FIG. 12, two first-type S-SSB slots and one second-type S-SSB slot are configured in one synchronization period. The frequency-domain resources corresponding to the first-type S-SSB slot are three S-SSB frequency-domain resources in frequency band 1 and two S-SSB frequency-domain resources in frequency band 0. The frequency-domain resource corresponding to the second-type S-SSB slot is one S-SSB frequency-domain resource in frequency band 1.

The first-type terminal may transmit an S-SSB on the first-type S-SSB synchronization resource. The first-type S-SSB synchronization resource occupies one or two first-type S-SSB slots in the time domain, and may occupy at least one S-SSB frequency-domain resource in frequency band 1 in the frequency domain. Optionally, the first-type S-SSB synchronization resource may also occupy at least one S-SSB frequency-domain resource in frequency band 0. Here, frequency band 1 may be considered as a default/mandatory frequency band, and frequency band 0 may be considered as an optional/auxiliary frequency band.

The second-type terminal may transmit an S-SSB on the second-type S-SSB synchronization resource that occupies one second-type S-SSB slot in the time domain and occupies one S-SSB frequency-domain resource in frequency band 1 in the frequency domain.

In addition, in an implementation, the first-type terminal may transmit an S-SSB using the second-type S-SSB synchronization resource, and/or the second-type terminal may also transmit an S-SSB using the first-type S-SSB synchronization resource. The following precondition exists in the implementation: the first-type terminal transmits an S-SSB at least on the first-type S-SSB frequency-domain resource in a first frequency band, and the second-type terminal transmits an S-SSB at least on the second-type S-SSB frequency-domain resource in the first frequency band. As in FIG. 12 as an example, the precondition is that the first-type terminal transmits an S-SSB at least on the first-type S-SSB frequency-domain resource in frequency band 1, and the second-type terminal transmits an S-SSB at least on the second-type S-SSB frequency-domain resource in frequency band 1.

The first-type terminal may receive an S-SSB on the first-type S-SSB synchronization resource, and optionally, the first-type terminal may also receive an S-SSB on the second-type S-SSB synchronization resource. As in FIG. 12 as an example, the first-type terminal receives an S-SSB on each first-type S-SSB frequency-domain resource in frequency band 1, and the first-type terminal may also receive the S-SSB on each second-type S-SSB frequency-domain resource in frequency band 1.

The second-type terminal may receive an S-SSB on the second-type S-SSB synchronization resource, and optionally, the second-type terminal may also receive an S-SSB on the first-type S-SSB synchronization resource. As in FIG. 12 as an example, the second-type terminal receives an S-SSB on each second-type S-SSB frequency-domain resource in frequency band 1, and the second-type terminal may also receive an S-SSB on each first-type S-SSB frequency-domain resource in frequency band 1.

The preferred implementations of the disclosure are described in detail in conjunction with accompanying drawings. However, the disclosure is not limited to the particular details in the above implementations. Within the range of the technical idea of the disclosure, multiple simple variations can be made to the technical solutions of the disclosure, and these variations all fall within the scope of protection of the disclosure. For example, the particular technical features described in the above particular implementations may be combined in any suitable way without conflict. To avoid unnecessary repetition, the possible combinations are not described in the disclosure. For example, different implementations of the disclosure may also be combined arbitrarily without departing from the concept of the disclosure, which shall be considered as content disclosed by the disclosure as well. Also, without conflict, the various embodiments described in the disclosure and/or technical features of the various embodiments may be combined with the related art arbitrarily, and the technical solutions obtained via the combination shall also fall within the scope of protection of the disclosure.

It is also to be understood that, in the method embodiments of the disclosure, the serial numbers of the above operations do not imply the sequential order in which the operations are performed, and shall not construe any limitation to the implementation of the embodiments of the disclosure. The order in which the operations are performed should be decided by their functions and internal logics. In addition, in the embodiments of the disclosure, the terms “downlink”, “uplink” and “sidelink” are used for representing the transmission direction of signals or data. “Downlink” indicates that the transmission direction of signals or data is a first direction of sending from a station to user equipment in a cell. “Uplink” indicates that the transmission direction of signals or data is a second direction of sending from user equipment in a cell to a station. “Sidelink” indicates that the transmission direction of signals or data is a third direction of sending from user equipment 1 to user equipment 2. For example, “downlink signal” represents that the transmission direction of the signal is the first direction. In addition, in the embodiments of the disclosure, the term “and/or” herein merely describes a relation between associated objects, representing that three relations may exist. In particular, A and/or B may represent following three cases: existence of A alone, existence of both A and B, and existence of B alone. Additionally, the character “/” generally indicates that the contextual objects are in an “or” relationship.

FIG. 13 illustrates a first schematic structural diagram of a composition of a device for resource configuration according to the embodiments of the disclosure. The device is applied to a terminal. As illustrated in FIG. 13, the device includes an acquiring unit 1301.

The acquiring unit 1301 is configured to acquire first configuration information. The first configuration information is used for determining a first-type sidelink synchronization signal block (S-SSB) synchronization resource and a second-type S-SSB synchronization resource. The first-type S-SSB synchronization resource corresponds to a first-type terminal, and the second-type S-SSB synchronization resource corresponds to a second-type terminal. The first-type terminal has a higher capability than the second-type terminal.

In some implementations, the first configuration information includes first time-domain configuration information and second time-domain configuration information. The first time-domain configuration information is used for determining a first-type synchronization slot, and the second time-domain configuration information is used for determining a second-type synchronization slot. The first-type synchronization slot corresponds to the first-type S-SSB synchronization resource, and the second-type synchronization slot corresponds to the second-type S-SSB synchronization resource.

In some implementations, the first time-domain configuration information includes at least one of: a first parameter indicating a first synchronization period; a second parameter indicating the number of first-type synchronization slots included in the first synchronization period; a third parameter indicating a slot offset of the first first-type synchronization slot in the first synchronization period with respect to a boundary of the first synchronization period; or a fourth parameter indicating a slot interval between two adjacent first-type synchronization slots within the first synchronization period.

In some implementations, the second time-domain configuration information includes at least one of: a fifth parameter indicating a second synchronization period; a sixth parameter indicating the number of second-type synchronization slots included in the second synchronization period; a seventh parameter indicating a slot offset of the first second-type synchronization slot in the second synchronization period with respect to a boundary of the second synchronization period; or an eighth parameter indicating a slot interval between two adjacent second-type synchronization slots in the second synchronization period.

In some implementations, the first synchronization period configured by the first time-domain configuration information is same as the second synchronization period configured by the second time-domain configuration information.

In some implementations, the first synchronization period configured by the first time-domain configuration information is different from the second synchronization period configured by the second time-domain configuration information.

In some implementations, the length of the first synchronization period is L times the length of the second synchronization period, L being an integer greater than 1.

In some implementations, the first configuration information includes third time-domain configuration information and first information. The third time-domain configuration information and the first information are used for determining the first-type synchronization slot and the second-type synchronization slot. The first-type synchronization slot corresponds to the first-type S-SSB synchronization resource, and the second-type synchronization slot corresponds to the second-type S-SSB synchronization resource.

In some implementations, all synchronization slots configured by the third time-domain configuration information are the first-type synchronization slots, and a first portion of synchronization slots configured by the third time-domain configuration information are the second-type synchronization slots, and the first portion of synchronization slots are indicated by the first information.

In some implementations, the first information indicates the number N of synchronization slots contained in the first portion of synchronization slots.

In some implementations, the first portion of synchronization slots include the last N synchronization slots in all the synchronization slots, or the first portion of synchronization slots include the first N synchronization slots among all the synchronization slots.

In some implementations, the first information includes a first bitmap. P bits in the first bitmap have a correspondence relationship with P synchronization slots. The P synchronization slots are all the synchronization slots. A value of each bit indicates whether a synchronization slot corresponding to the bit belongs to the first portion of synchronization slots.

In some implementations, the first information includes a first pattern index indicating a first pattern of multiple patterns, and each pattern of the multiple patterns corresponds to a respective synchronization slot pattern to which the first portion of synchronization slots correspond.

In some implementations, a second portion of synchronization slots configured by the third time-domain configuration information are the first-type synchronization slots, and a first portion of synchronization slots configured by the third time-domain configuration information are the second-type synchronization slots. The first portion of synchronization slots and/or the second portion of synchronization slots are indicated by the first information.

In some implementations, the first information indicates the number N of synchronization slots contained in the first portion of synchronization slots and/or the number M of synchronization slots contained in the second portion of synchronization slots.

In some implementations, the first portion of synchronization slots include the last N synchronization slots among all the synchronization slots, and the second portion of synchronization slots include the first M synchronization slots among all the synchronization slots; or the first portion of synchronization slots include the first N synchronization slots among all the synchronization slots, and the second portion of synchronization slots include the last M synchronization slots among all the synchronization slots.

In some implementations, the first information includes a second bitmap. P bits in the second bitmap have a correspondence relationship with P synchronization slots. The P synchronization slots are the first portion of synchronization slots and the second portion of synchronization slots. A value of each bit indicates whether a synchronization slot corresponding to the bit belongs to the first portion of synchronization slots or the second portion of synchronization slots.

In some implementations, the first information includes a second pattern index indicating a second pattern of multiple patterns, and each pattern of the multiple patterns corresponds to a respective synchronization slot pattern to which the first portion of synchronization slots and the second portion of synchronization slots correspond.

In some implementations, the third time-domain configuration information includes at least one of: a ninth parameter indicating a third synchronization period; a tenth parameter indicating the number of synchronization slots included in the third synchronization period; an eleventh parameter indicating a slot offset of the first synchronization slot in the third synchronization period with respect to a boundary of the third synchronization period; or a twelfth parameter indicating a slot interval between two adjacent synchronization slots in the third synchronization period.

In some implementations, the first configuration information further includes first frequency-domain configuration information and second frequency-domain configuration information. The first frequency-domain configuration information is used for determining a first-type S-SSB frequency-domain resource, and the second frequency-domain configuration information is used for determining a second-type S-SSB frequency-domain resource. The first-type S-SSB frequency-domain resource corresponds to the first-type S-SSB synchronization resource, and the second-type S-SSB frequency-domain resource corresponds to the second-type S-SSB synchronization resource.

In some implementations, the first frequency-domain configuration information is used for configuring the first-type S-SSB frequency-domain resource for one or more frequency bands, and the second frequency-domain configuration information is used for configuring the second-type S-SSB frequency-domain resources for one or more frequency bands.

In some implementations, the first configuration information further includes third frequency-domain configuration information. The third frequency-domain configuration information is used for determining a first-type S-SSB frequency-domain resource and a second-type S-SSB frequency-domain resource. The first-type S-SSB frequency-domain resource corresponds to the first-type S-SSB synchronization resource, and the second-type S-SSB frequency-domain resource corresponds to the second-type S-SSB synchronization resource.

In some implementations, the third frequency-domain configuration information is used for configuring the first-type S-SSB frequency-domain resource and the second-type S-SSB frequency-domain resource for one or more frequency bands.

In some implementations, the first-type S-SSB frequency-domain resource has a mapping relationship with the first-type synchronization slot, and the second-type S-SSB frequency-domain resource has a mapping relationship with the second-type synchronization slot.

In some implementations, the device further includes a transmitting/receiving unit 1302. The transmitting/receiving unit 1302 is configured to: in case that the terminal is the first-type terminal, transmit or receive an S-SSB on the first-type S-SSB synchronization resource, or transmit or receive an S-SSB on the first-type S-SSB synchronization resource and the second-type S-SSB synchronization resource.

In some implementations, the transmitting/receiving unit 1302 is configured to transmit or receive an S-SSB on a part of the first-type S-SSB synchronization resource, or on all of the first-type S-SSB synchronization resource.

In some implementations, the part of the first-type S-SSB synchronization resource includes a part of first-type synchronization slots corresponding to the first-type S-SSB synchronization resource and/or a part of first-type S-SSB frequency-domain resources corresponding to the first-type S-SSB synchronization resource.

In some implementations, the transmitting/receiving unit 1302 is further configured to: in case that the terminal is the second-type terminal, transmit or receive an S-SSB on the second-type S-SSB synchronization resource, or transmit or receive an S-SSB on the second-type S-SSB synchronization resource and the first-type S-SSB synchronization resource.

In some implementations, the transmitting/receiving unit 1302 is further configured to: transmit or receive an S-SSB on a part of the second-type S-SSB synchronization resource, or on all of the second-type S-SSB synchronization resource.

In some implementations, the part of the second-type S-SSB synchronization resource includes a part of second-type synchronization slots corresponding to the second-type S-SSB synchronization resource and/or a part of a second-type S-SSB frequency-domain resource corresponding to the second-type S-SSB synchronization resource.

In some implementations, the first configuration information is configured by a network, or is preconfigured.

Those skilled in the art should understand that relevant description of the above device for resource configuration according to the embodiments of the disclosure can be understood with reference to the relevant description of the method for resource configuration according to the embodiments of the disclosure.

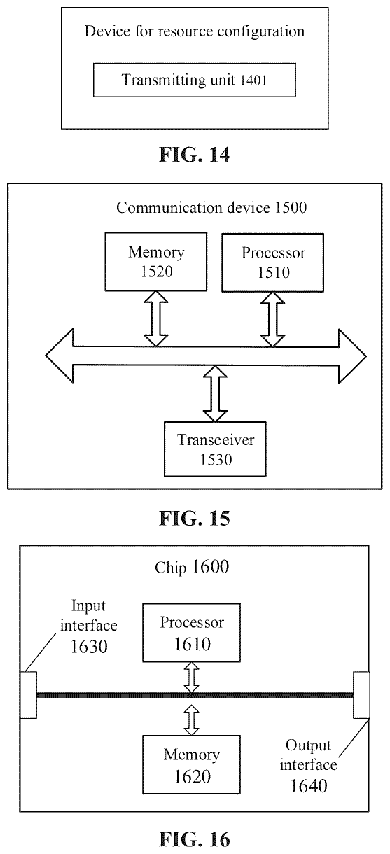

FIG. 14 illustrates a second schematic structural diagram of a composition of a device for resource configuration according to embodiments of the disclosure. The device is applied to a network device. As illustrated in FIG. 14, the device includes a transmitting unit 1401.

The transmitting unit 1401 is configured to transmit first configuration information. The first configuration information is used for determining a first-type sidelink synchronization signal block (S-SSB) synchronization resource and a second-type S-SSB synchronization resource. The first-type S-SSB synchronization resource corresponds to a first-type terminal, and the second-type S-SSB synchronization resource corresponds to a second-type terminal. The first-type terminal has a higher capability than the second-type terminal.

In some implementations, the first configuration information includes first time-domain configuration information and second time-domain configuration information. The first time-domain configuration information is used for determining a first-type synchronization slot, and the second time-domain configuration information is used for determining a second-type synchronization slot. The first-type synchronization slot corresponds to the first-type S-SSB synchronization resource, and the second-type synchronization slot corresponds to the second-type S-SSB synchronization resource.

In some implementations, the first time-domain configuration information includes at least one of: a first parameter indicating a first synchronization period; a second parameter indicating the number of first-type synchronization slots included in the first synchronization period; a third parameter indicating a slot offset of the first first-type synchronization slot in the first synchronization period with respect to a boundary of the first synchronization period; or a fourth parameter indicating a slot interval between two adjacent first-type synchronization slots within the first synchronization period.

In some implementations, the second time-domain configuration information includes at least one of: a fifth parameter indicating a second synchronization period; a sixth parameter indicating the number of second-type synchronization slots included in the second synchronization period; a seventh parameter indicating a slot offset of the first second-type synchronization slot in the second synchronization period with respect to a boundary of the second synchronization period; or an eighth parameter indicating a slot interval between two adjacent second-type synchronization slots in the second synchronization period.

In some implementations, the first synchronization period configured by the first time-domain configuration information is same as the second synchronization period configured by the second time-domain configuration information.

In some implementations, the first synchronization period configured by the first time-domain configuration information is different from the second synchronization period configured by the second time-domain configuration information.

In some implementations, the length of the first synchronization period is L times the length of the second synchronization period, L being an integer greater than 1.

In some implementations, the first configuration information includes third time-domain configuration information and first information. The third time-domain configuration information and the first information are used for determining the first-type synchronization slot and the second-type synchronization slot. The first-type synchronization slot corresponds to the first-type S-SSB synchronization resource, and the second-type synchronization slot corresponds to the second-type S-SSB synchronization resource.

In some implementations, all synchronization slots configured by the third time-domain configuration information are the first-type synchronization slots; and a first portion of synchronization slots configured by the third time-domain configuration information are the second-type synchronization slots, and the first portion of synchronization slots are indicated by the first information.

In some implementations, the first information indicates the number N of synchronization slots contained in the first portion of synchronization slots.

In some implementations, the first portion of synchronization slots include the last N synchronization slots among all the synchronization slots, or the first portion of synchronization slots include the first N synchronization slots among all the synchronization slots.

In some implementations, the first information includes a first bitmap. P bits in the first bitmap have a correspondence relationship with P synchronization slots. The P synchronization slots are all the synchronization slots. A value of each bit indicates whether a synchronization slot corresponding to the bit belongs to the first portion of synchronization slots.

In some implementations, the first information includes a first pattern index indicating a first pattern of multiple patterns, and each pattern of the multiple patterns corresponds to a respective synchronization slot pattern to which the first portion of synchronization slots correspond.

In some implementations, a second portion of synchronization slots configured by the third time-domain configuration information are the first-type synchronization slots, and a first portion of synchronization slots configured by the third time-domain configuration information are the second-type synchronization slots. The first portion of synchronization slots and/or the second portion of synchronization slots are indicated by the first information.

In some implementations, the first information indicates the number N of synchronization slots contained in the first portion of synchronization slots and/or the number M of synchronization slots contained in the second portion of synchronization slots.

In some implementations, the first portion of synchronization slots include the last N synchronization slots among all the synchronization slots, and the second portion of synchronization slots include the first M synchronization slots among all the synchronization slots; or the first portion of synchronization slots include the first N synchronization slots among all the synchronization slots, and the second portion of synchronization slots include the last M synchronization slots among all the synchronization slots.

In some implementations, the first information includes a second bitmap. P bits in the second bitmap have a correspondence relationship with P synchronization slots. The P synchronization slots are the first portion of synchronization slots and the second portion of synchronization slots. A value of each bit indicates whether a synchronization slot corresponding to the bit belongs to the first portion of synchronization slots or the second portion of synchronization slots.

In some implementations, the first information includes a second pattern index indicating a second pattern of multiple patterns, and each pattern of the multiple patterns corresponds to a respective synchronization slot pattern to which the first portion of synchronization slots and the second portion of synchronization slots correspond.

In some implementations, the third time-domain configuration information includes at least one of: a ninth parameter indicating a third synchronization period; a tenth parameter indicating the number of synchronization slots included in the third synchronization period; an eleventh parameter indicating a slot offset of the first synchronization slot in the third synchronization period with respect to a boundary of the third synchronization period; or a twelfth parameter indicating a slot interval between two adjacent synchronization slots in the third synchronization period.

In some implementations, the first configuration information further includes first frequency-domain configuration information and second frequency-domain configuration information. The first frequency-domain configuration information is used for determining a first-type S-SSB frequency-domain resource, and the second frequency-domain configuration information is used for determining a second-type S-SSB frequency-domain resource. The first-type S-SSB frequency-domain resource corresponds to the first-type S-SSB synchronization resource, and the second-type S-SSB frequency-domain resource corresponds to the second-type S-SSB synchronization resource.

In some implementations, the first frequency-domain configuration information is used for configuring the first-type S-SSB frequency-domain resource for one or more frequency bands; and the second frequency-domain configuration information is used for configuring the second-type S-SSB frequency-domain resources for one or more frequency bands.

In some implementations, the first configuration information further includes third frequency-domain configuration information. The third frequency-domain configuration information is used for determining a first-type S-SSB frequency-domain resource and a second-type S-SSB frequency-domain resource. The first-type S-SSB frequency-domain resource corresponds to the first-type S-SSB synchronization resource, and the second-type S-SSB frequency-domain resource corresponds to the second-type S-SSB synchronization resource.

In some implementations, the third frequency-domain configuration information is used for configuring the first-type S-SSB frequency-domain resource and the second-type S-SSB frequency-domain resource for one or more frequency bands.

In some implementations, the first-type S-SSB frequency-domain resource has a mapping relationship with the first-type synchronization slot, and the second-type S-SSB frequency-domain resource has a mapping relationship with the second-type synchronization slot.

Those skilled in the art should understand that relevant description of the above device for resource configuration according to the embodiments of the disclosure can be understood with reference to the relevant description of the method for resource configuration according to the embodiments of the disclosure.

FIG. 15 illustrates a schematic structural diagram of a communication device 1500 according to the embodiments of the disclosure. The communication device may be a terminal, or a network device. The communication device 1500 illustrated in FIG. 15 includes a processor 1510. The processor 1510 may call and run a computer program from a memory to implement the method according to the embodiments of the disclosure.

Optionally, as illustrated in FIG. 15, the communication device 1500 may further include a memory 1520. The processor 1510 may call and run a computer program from the memory 1520 to implement the method according to the embodiments of the disclosure.

The memory 1520 may be a device independent from the processor 1510, or may be integrated in the processor 1510.

Optionally, as illustrated in FIG. 15, the communication device 1500 may further include a transceiver 1530. The processor 1510 may control the transceiver 1530 to communicate with other devices, in particular to send information or data to other devices or receive information or data from other devices.

The transceiver 1530 may include a transmitter and a receiver. The transceiver 1530 may further include antenna(s), and the number of antennas may be one or more.

Optionally, the communication device 1500 may particularly be the network device of the embodiments of the disclosure, and the communication device 1500 may implement corresponding flows implemented by the network device in various methods according to the embodiments of the disclosure, which is not described here again for simplicity.

Optionally, the communication device 1500 may be a mobile terminal/terminal according to the embodiments of the disclosure, and the communication device 1500 may implement corresponding flows implemented by the mobile terminal/terminal in various methods according to the embodiments of the disclosure, which is not described here again for simplicity.

FIG. 16 illustrates a schematic structural diagram of a chip according to the embodiments of the disclosure. The chip 1600 illustrated in FIG. 16 includes a processor 1610. The processor 1610 may call and run a computer program from a memory to implement the method according to the embodiments of the disclosure.

Optionally, as illustrated in FIG. 16, the chip 1600 may further include a memory 1620. The processor 1610 may call and run a computer program from the memory 1620 to implement the method according to the embodiments of the disclosure.

The memory 1620 may be a device independent from the processor 1610, or may be integrated in the processor 1610.

Optionally, the chip 1600 may further include an input interface 1630. The processor 1610 may control the input interface 1630 to communicate with other devices or chips, in particularly to acquire information or data sent by other devices or chips.

Optionally, the chip 1600 may further include an output interface 1640. The processor 1610 may control the output interface 1640 to communicate with other devices or chips, in particularly to output information or data to other devices or chips.

Optionally, the chip may be applied to the network device of the embodiments of the disclosure, and the chip may implement corresponding flows implemented by the network device in various methods according to the embodiments of the disclosure, which is not described here again for simplicity.

Optionally, the chip may be applied to a mobile terminal/terminal according to the embodiments of the disclosure, and the chip may implement corresponding flows implemented by the mobile terminal/terminal in various methods according to the embodiments of the disclosure, which is not described here again for simplicity.

It should be understood that, the chip mentioned in the embodiments of the disclosure may also be referred to as a system-level chip, a system chip, a chip system or a system-on-chip.

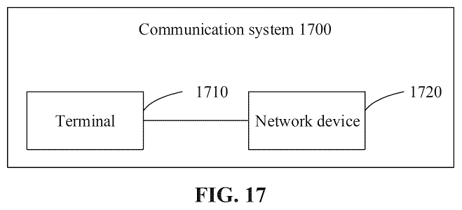

FIG. 17 illustrates a schematic block diagram of a communication system 1700 according to the embodiments of the disclosure. As illustrated in FIG. 17, the communication system 1700 includes a terminal 1710 and a network device 1720.

The terminal 1710 may implement corresponding functions implemented by a terminal in the above methods, and the network device 1720 may implement corresponding functions implemented by a network device in the above methods, which is not described here again for simplicity.

It should be understood that the processor of the embodiments of the disclosure may be an integrated circuit chip, and has the capability of signal processing. During implementation, the various steps of in the above method embodiment may be completed by an integrated logic circuit in hardware form or instructions in software form in a processor. The above processor may be a general-purpose processor, a digital signal processor (DSP), an application specific integrated circuit (ASIC), a field programmable gate array (FPGA), or another programmable logical device, a discrete gate or a transistor logical device, or a discrete hardware component. The first processor may implement or perform the various methods, steps or logic blocks disclosed in the embodiments of the disclosure. The universal processor may be a microprocessor or the processor may also be any conventional processor and the like. The steps of the methods disclosed in combination with the embodiments of the disclosure may be directly embodied as being performed and completed by a hardware decoding processor, or being performed and completed by a combination of hardware and software modules in a decoding processor. The software module may be located in a mature storage medium in the art such as a random access memory, a flash memory, a read-only memory, a programmable read-only memory, an electrically erasable programmable memory, or a register. The storage medium is in a memory, and a processor reads information from the memory to implement steps of the above methods in combination with the hardware.

It may be understood that the memory in the embodiments of the disclosure may be a volatile memory or a non-volatile memory, or may include both a volatile memory and a non-volatile memory. The non-volatile memory may be a read-only memory (ROM), a programmable ROM (PROM), an erasable PROM (RPROM), an electrically EPROM (EEPROM), or a flash memory. The volatile memory may be a random access memory (RAM), that is used as an external cache. By way of example, but not limiting description, RAMs in many forms are available, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a directly rambus RAM (DR RAM). It should be noted that, the memory in the system and method described herein is intended to include but not limited to memories of these and any other suitable types.

It should be understood that the memories are exemplary but not restrictive. For example, the memory in the embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), or a direct Rambus RAM (DR RAM). That is to say, the memory in the embodiments of the disclosure is intended to include but not limited to memories of these and any other suitable types.

The embodiments of the disclosure further provide a computer-readable storage medium for storing a computer program.

Optionally, the computer-readable storage medium may be applied to the network device of the embodiments of the disclosure, and the computer program enables a computer to implement corresponding procedures implemented by the network device in various methods according to the embodiments of the disclosure, which is not described here again for simplicity.

Optionally, the computer-readable storage medium may be applied to a mobile terminal/terminal according to the embodiments of the disclosure, and the computer program enables a computer to implement corresponding procedures implemented by the mobile terminal/terminal in various methods according to the embodiments of the disclosure, which is not described here again for simplicity.

The embodiments of the disclosure further provide a computer program product including computer program instructions.

Optionally, the computer program product may be applied to the network device of the embodiments of the disclosure, and instructions of the computer program product enable a computer to implement corresponding procedures implemented by the network device in various methods according to the embodiments of the disclosure, which is not described here again for simplicity.

Optionally, the computer program product may be applied to a mobile terminal/terminal according to the embodiments of the disclosure, and instructions of the computer program product enable a computer to implement corresponding procedures implemented by the mobile terminal/terminal in various methods according to the embodiments of the disclosure, which is not described here again for simplicity.

The embodiments of the disclosure further provide a computer program.

Optionally, the computer program may be applied to the network device of the embodiments of the disclosure, and the computer program, when running on a computer, enables the computer to implement corresponding procedures implemented by the network device in various methods according to the embodiments of the disclosure, which is not described here again for simplicity.

Optionally, the computer program may be applied to a mobile terminal/terminal according to the embodiments of the disclosure, and the computer program, when running on a computer, enables the computer to implement corresponding procedures implemented by the mobile terminal/terminal in various methods according to the embodiments of the disclosure, which is not described here again for simplicity.

Those of ordinary skill in the art may realize that the units and algorithm steps of various examples described in combination with the embodiments disclosed herein may be implemented by electronic hardware, or a combination of computer software and electronic hardware. Whether the functions are performed in form of hardware or software form depends on the specific application and design constraint conditions of the technical solution. Professionals may use a different method to realize the described function for each specific application, and such implementation should not be construed as extending beyond the scope of the disclosure

Those skilled in the art may clearly appreciate that for convenience and simplicity of description, regarding the particular operation procedures of the system, apparatus and units described above, reference may be made to corresponding flows in the foregoing method embodiment, and repeated description is not provided here.

In some embodiments provided in the disclosure, it is to be understood that the disclosed system, device and method may be implemented in other ways. For example, the apparatus embodiment described above is only exemplary, and for example, division of the units is only division in logic functions, and division may be made in other ways during practical implementation. For example, multiple units or components may be combined or integrated into another system, or some features may be neglected or not executed. In addition, coupling or direct coupling or communication connection between various displayed or discussed components may be indirect coupling or communication connection, implemented through some interfaces, devices or units, and may be electrical and mechanical or in other forms.

The units described as separate components may or may not be physically discrete from one another. Components displayed as units may or may not be physical units, and can be located at the same place or may be distributed to multiple network units. Some or all of the units may be chosen to realize the purpose of the solution of the embodiments according to actual requirements.

Additionally, various functional units in the embodiments of the disclosure may be integrated in one processing unit, or may exist separately physically, or two or more units may be integrated in one unit.

If the functions are implemented in form of software functional units and sold or used as independent product, the functions may be stored in a computer-readable storage medium. Based on such understanding, the technical solution of the disclosure substantially or the part thereof making contributions to the related art or a part of the technical solution may be embodied in a software product. The computer software product is stored in a storage medium, and includes several instructions to enable a computer device (which may be a personal computer, a server, a network device or the like) to perform all or some steps of the method according to various embodiments of the disclosure. The foregoing storage medium includes various media capable of storing program codes such as a USB flash drive, a mobile hard disk drive, a read-only memory (ROM), a random access memory (RAM), a magnetic disc, or a compact disc (CD).

The foregoing is merely the implementations of the disclosure, but the scope of protection of the disclosure is not limited thereto. Any modification or replacement that are easily conceivable by those skilled in the art within the technical range disclosed by the disclosure shall fall within the scope of protection of the disclosure. Therefore, the scope of protection of the disclosure should be subjected to the claimed scope of the claims.

1. A method for resource configuration, comprising:
acquiring, by a terminal, first configuration information, wherein the first configuration information is used for determining a first-type sidelink synchronization signal block (S-SSB) synchronization resource and a second-type S-SSB synchronization resource, the first-type S-SSB synchronization resource corresponds to a first-type terminal, and the second-type S-SSB synchronization resource corresponds to a second-type terminal, and the first-type terminal has a higher capability than the second-type terminal.

2. The method of claim 1, wherein the first configuration information comprises first time-domain configuration information and second time-domain configuration information, the first time-domain configuration information is used for determining a first-type synchronization slot, and the second time-domain configuration information is used for determining a second-type synchronization slot, and the first-type synchronization slot corresponds to the first-type S-SSB synchronization resource, and the second-type synchronization slot corresponds to the second-type S-SSB synchronization resource.

3. The method of claim 2, wherein the first time-domain configuration information comprises at least one of:
a first parameter indicating a first synchronization period; a second parameter indicating a number of first-type synchronization slots comprised in the first synchronization period; a third parameter indicating a slot offset of the first first-type synchronization slot in the first synchronization period with respect to a boundary of the first synchronization period; or a fourth parameter indicating a slot interval between two adjacent first-type synchronization slots within the first synchronization period; and/or,
wherein the second time-domain configuration information comprises at least one of:
a fifth parameter indicating a second synchronization period; a sixth parameter indicating a number of second-type synchronization slots comprised in the second synchronization period; a seventh parameter indicating a slot offset of the first second-type synchronization slot in the second synchronization period with respect to a boundary of the second synchronization period; or an eighth parameter indicating a slot interval between two adjacent second-type synchronization slots in the second synchronization period.

4. The method of claim 3, wherein the first synchronization period configured by the first time-domain configuration information is same as or different from the second synchronization period configured by the second time-domain configuration information.

5. The method of claim 4, wherein a length of the first synchronization period is L times a length of the second synchronization period, L being an integer greater than 1.

6. The method of claim 1, wherein the first configuration information comprises third time-domain configuration information and first information, the third time-domain configuration information and the first information are used for determining a first-type synchronization slot and a second-type synchronization slot, and the first-type synchronization slot corresponds to the first-type S-SSB synchronization resource, and the second-type synchronization slot corresponds to the second-type S-SSB synchronization resource.

7. The method of claim 6, wherein all synchronization slots configured by the third time-domain configuration information are the first-type synchronization slot, and a first portion of synchronization slots configured by the third time-domain configuration information is the second-type synchronization slot, and the first portion of synchronization slots is indicated by the first information.

8. The method of claim 7, wherein the first information indicates a number N of synchronization slots contained in the first portion of synchronization slots, wherein
the first portion of synchronization slots comprise last N synchronization slots in all the synchronization slots; or
the first portion of synchronization slots comprise first N synchronization slots in all the synchronization slots.

9. The method of claim 7, wherein the first information comprises a first bitmap, P bits in the first bitmap have a correspondence relationship with P synchronization slots, the P synchronization slots are all the synchronization slots, and a value of each bit indicates whether a synchronization slot corresponding to the bit belongs to the first portion of synchronization slots; or
wherein the first information comprises a first pattern index indicating a first pattern of a plurality of patterns, and each pattern of the plurality of patterns corresponds to a respective synchronization slot pattern to which the first portion of synchronization slots correspond.

10. The method of claim 2, wherein the first configuration information further comprises first frequency-domain configuration information and second frequency-domain configuration information, the first frequency-domain configuration information is used for determining a first-type S-SSB frequency-domain resource, and the second frequency-domain configuration information is used for determining a second-type S-SSB frequency-domain resource, and the first-type S-SSB frequency-domain resource corresponds to the first-type S-SSB synchronization resource, and the second-type S-SSB frequency-domain resource corresponds to the second-type S-SSB synchronization resource.

11. A method for resource configuration, comprising:
transmitting, by a network device, first configuration information, wherein the first configuration information is used for determining a first-type sidelink synchronization signal block (S-SSB) synchronization resource and a second-type S-SSB synchronization resource, the first-type S-SSB synchronization resource corresponds to a first-type terminal, and the second-type S-SSB synchronization resource corresponds to a second-type terminal, and the first-type terminal has a higher capability than the second-type terminal.

12. The method of claim 11, wherein the first configuration information comprises first time-domain configuration information and second time-domain configuration information, the first time-domain configuration information is used for determining a first-type synchronization slot, and the second time-domain configuration information is used for determining a second-type synchronization slot, and the first-type synchronization slot corresponds to the first-type S-SSB synchronization resource, and the second-type synchronization slot corresponds to the second-type S-SSB synchronization resource.

13. The method of claim 12, wherein the first time-domain configuration information comprises at least one of:
a first parameter indicating a first synchronization period; a second parameter indicating a number of first-type synchronization slots comprised in the first synchronization period; a third parameter indicating a slot offset of the first first-type synchronization slot in the first synchronization period with respect to a boundary of the first synchronization period; or a fourth parameter indicating a slot interval between two adjacent first-type synchronization slots within the first synchronization period, and/or
wherein the second time-domain configuration information comprises at least one of:
a fifth parameter indicating a second synchronization period; a sixth parameter indicating a number of second-type synchronization slots comprised in the second synchronization period; a seventh parameter indicating a slot offset of the first second-type synchronization slot in the second synchronization period with respect to a boundary of the second synchronization period; or an eighth parameter indicating a slot interval between two adjacent second-type synchronization slots in the second synchronization period.

14. The method of claim 13, wherein the first synchronization period configured by the first time-domain configuration information is same as or different from the second synchronization period configured by the second time-domain configuration information.

15. The method of claim 11, wherein the first configuration information comprises third time-domain configuration information and first information, the third time-domain configuration information and the first information are used for determining a first-type synchronization slot and a second-type synchronization slot, and the first-type synchronization slot corresponds to the first-type S-SSB synchronization resource, and the second-type synchronization slot corresponds to the second-type S-SSB synchronization resource.

16. The method of claim 15, wherein a second portion of synchronization slots configured by the third time-domain configuration information is the first-type synchronization slot, and a first portion of synchronization slots configured by the third time-domain configuration information is the second-type synchronization slot, and the first portion of synchronization slots and/or the second portion of synchronization slots are indicated by the first information.

17. The method of claim 16, wherein the first information indicates a number N of synchronization slots contained in the first portion of synchronization slots and/or a number M of synchronization slots contained in the second portion of synchronization slots, wherein the first portion of synchronization slots comprise last N synchronization slots among all synchronization slots, and the second portion of synchronization slots comprise first M synchronization slots among all the synchronization slots; or
the first portion of synchronization slots comprise first N synchronization slots among all the synchronization slots, and the second portion of synchronization slots comprise last M synchronization slots among all the synchronization slots.

18. The method of claim 16, wherein the first information comprises a second bitmap, P bits in the second bitmap have a correspondence relationship with P synchronization slots, the P synchronization slots are the first portion of synchronization slots and the second portion of synchronization slots, and a value of each bit indicates whether a synchronization slot corresponding to the bit belongs to the first portion of synchronization slots or the second portion of synchronization slots; or
wherein the first information comprises a second pattern index indicating a second pattern of a plurality of patterns, and each pattern of the plurality of patterns corresponds to a respective synchronization slot pattern to which the first portion of synchronization slots and the second portion of synchronization slots correspond.

19. The method of claim 15, wherein the third time-domain configuration information comprises at least one of:
a ninth parameter indicating a third synchronization period;
a tenth parameter indicating a number of synchronization slots comprised in the third synchronization period;
an eleventh parameter indicating a slot offset of the first synchronization slot in the third synchronization period with respect to a boundary of the third synchronization period; or
a twelfth parameter indicating a slot interval between two adjacent synchronization slots in the third synchronization period.

20. A communication device comprising a processor and a memory, wherein the memory is configured to store a computer program, and the processor is configured to call and run the computer program stored in the memory to perform:
acquiring first configuration information, wherein the first configuration information is used for determining a first-type sidelink synchronization signal block (S-SSB) synchronization resource and a second-type S-SSB synchronization resource, the first-type S-SSB synchronization resource corresponds to a first-type terminal, and the second-type S-SSB synchronization resource corresponds to a second-type terminal, and the first-type terminal has a higher capability than the second-type terminal.
